(19) United States
(12) Patent Application Publication
(10) Pub. No.: US 2026/0342279 A1
(43) Pub. Date: Oct. 29, 2026

(54) HELIOSTAT ARRANGEMENT

(71) Applicant: HELIOSYNC OÜ, Pärnu, Pãrnumaa (EE)

(72) Inventor: BERNHARD WERNER ADAMS, Waldbronn (DE)

(73) Assignee: HELIOSYNC OU, Pärnu, Pärnumaa (EE)

(21) Appl. No.: 19/111,726

(22) PCT Filed: Sep. 14, 2023
(86) PCT No.: PCT/EP2023/025398

§ 371 Date: Mar. 13, 2025

Related U.S. Application Data
(60) Provisional application No. 63/406,854, filed on Sep. 15, 2022.
(60) Provisional application No. 63/423,095, filed on Nov. 7, 2022.
(60) Provisional application No. 63/431,691, filed on Dec. 10, 2022.
(60) Provisional application No. 63/531,796, filed on Aug. 9, 2023.

(51) Int. Cl. H02S 40/22

(52) U.S. Cl. CPC H02S 40/22

(57) ABSTRACT

The present disclosure relates to a concentrated solar power facility comprises a sunlight collector having a sunlight collecting area; a plurality of mirror arrangements for reflecting sunlight onto the sunlight collector; a plurality of light modulating retroreflectors for reflecting modulated light from the sunlight collector back to the mirrors; a plurality of light sensors arranged to receive light reflected back to the mirrors and to output a light detection signal in response to the reception of modulated light reflected back to the mirrors and a light signal evaluation stage for de-modulating the light detection signal and for generating a mirror adjustment signal light signal.

### CROSS-REFERENCE TO RELATED APPLICATIONS

This application is the U.S. National Phase under 35. U.S.C. § 371 of International Application No. PCT/EP2023/025398, filed on Sep. 14, 2023, which claims priority to U.S. provisional application No. 63/531,796, filed on Aug. 9, 2023, to U.S. provisional application No. 63/431,691, filed on Dec. 10, 2022, to U.S. provisional application No. 63/423,095, filed on Nov. 7, 2022, and to U.S. provisional application No. 63/406,854, filed on Sep. 15, 2022. The disclosures of the above-described applications are hereby incorporated by reference in their entirety.

### FIELD OF THE INVENTION

The present disclosure relates to the thermal use of solar energy and, more particularly, to improvements in the field of concentrated solar power.

### BACKGROUND

In view of increasing costs for fossil energy and the decreasing supplies thereof, and given global warming, the use of renewable energy becomes both more and more important and economically interesting. It is particularly interesting to use solar radiation, either by directly converting sunlight to electric energy with photovoltaic cells or by converting sunlight to heat.

For converting sunlight to heat, a fluid such as a liquid, a gas, or a granular solid capable of flowing, is typically heated by sunlight falling onto a collector through which the fluid flows. The thermodynamics of the Carnot cycle implies that the energy that can be collected from heated fluid is dependent on both the temperature to which the fluid is heated and the temperature to which the heated fluid can subsequently be cooled down, typically e.g. to ambient temperature. For demanding applications, the fluid temperature is increased by concentrating solar radiation onto the collector using a plurality of mirrors. In this manner, it is possible to generate electric energy using the heated fluid or to generate heat for chemicals processes, such as for water thermolysis requiring up to 1500 °C or for salt water desalination. It should be understood that by using concentrators such as mirrors, economic advantages can be obtained as well, given that e.g. heat engines converting thermal energy to electric energy are a major cost factor of solar power arrangements that should be kept low, which in turn can be done by concentrating sunlight onto them.

However, concentrating solar radiation onto a heat collector during an entire day requires re-adjustment of the mirror as the position of the sun in the sky shows both diurnal and annual variations which the mirrors must follow. Closely following the movement of the sun across the sky requires to frequently adjust the alignment of the mirrors so that the light reflected by the mirror is kept on the collector. In addition, the alignment should be sufficiently stable even under the adverse conditions typically met at a concentrated solar power facility.

Mirrors—or rather entire mirror arrangements—following the sun are called heliostats and of course, basically all heliostats in a concentrated solar power arrangement should be adjusted. Now, while the importance of the task to keep the reflection of the sun from any given mirror on the collector is simple to understand, the actual technology needed is demanding, particularly when a low cost solution is needed.

Setting the actual orientation of a mirror only once and subsequently re-adjusting the orientation only in view of the well known and predictable path of the sun across the sky requires a very stable and precise mirror positioning arrangement, which, in turn, is costly, in particular because different heliostats in a heliostat array will need to be adjusted differently and because environmental influences such as wind gusts must be accounted for. The stability requirements can be relaxed—and hence production cost can be lowered—if more frequent adjustment is effected, but to this end, in view of the large number of mirrors in a typical concentrated solar power facility, determining and correcting a current orientation should be sufficiently fast.

To this end, it has been suggested in the art to reflect light received at the collector back to the mirrors using retroreflectors, and to determine the orientation of the mirrors in view of retroreflected light sensed at the location of the respective mirrors. By using a plurality of retroreflectors spaced apart and distinguishing the light received from these retroreflectors at the heliostats, a current orientation of the mirror can be determined and deviations from a target orientation can be corrected using controlled actuators. To distinguish the different retroreflectors, it has inter alia been suggested to modulate the retroreflected light. Such an arrangement is advantageous in that all mirrors can be more or less simultaneously aligned, allowing for frequent updates of the alignment and thus quasi-continuous correction of each heliostat in an array.

In more detail, in US2012/0279485A1, methods and systems for managing heliostat aiming toward a target are described. Solar rays incident on a reflective surface of a heliostat mirror are reflected toward the target. One or more optical signalers are arranged at positions about the target. An optical signal received from one of the one or more optical signalers is detected and an error in an orientation of the reflective surface is determined based on the optical signal. The one or more optical signalers can include multiple retroreflectors positioned about the target. The optical signal can be received from a particular one of the retroreflectors. It is suggested that determining the error in the orientation may include determining a frequency of changes in the properties of light that forms the optical signal and, based on the frequency and determining that the optical signal was received from a particular one of the multiple retroreflectors. It is also suggested that where the signals are retroreflectors, various techniques can be used to differentiate the signals. For example, it is suggested that the (modulation) frequency of the light reflected by each retroreflector can be different in that the reflected light from the retroreflectors can be optically chopped by placing a rotating partial disk in front of the retroreflector. If the reflection from each retroreflector is modulated with a different frequency, a simple examination of the intensity variation over time of light hitting a sensor is said to allow to resolve which retroreflector the light is coming from. It is suggested that the sensor could e.g. be a semiconductor IR (infrared) detector diode or a small solar PV (photovoltaic) cell.

From WO2019/060959, a system, method and apparatus for concentrating incident radiation from a source onto a target is known, using heliostat tracking of the sun in concentrated solar power generators. In more detail, the known system for collecting and concentrating radiant energy from a source onto a target comprises a plurality of reflectors, each having a reflective surface for reflecting the radiant energy onto the target, an actuator tor adjustment of the reflective surface relative to the target, and a photodetector for detection of radiant energy; and, one or more retroreflectors fixed relative to the target; wherein the photodetector is configured to maintain a fixed field of view of at least some of the one or more retroreflectors, such that the actuator adjusts the reflective surface until the photodetector senses retroreflected radiant energy from the one or more retroreflectors, the retroreflected radiant energy being a retroreflection of the radiant energy reflected from the source by the reflective surface. It is suggested that the retroreflectors are corner cube mirrors or prisms where the corner cubes have 90° surfaces and heat resistant material such as ceramic or glass or metal. Optionally, the retroreflectors are suggested to be internally reflective spheres. Preferably, the internally reflective spheres are a multitude of transparent beads of material with a refractive index selected such that incident radiation is internally reflected within the bead and emerges as reflected radiation with a predetermined angular beam spread to the incident radiation (including an angular spread of near 0°). It is stated that a retroreflectors within the spot of sunlight reflected by the heliostat would appear bright to the Image sensor for a given heliostat, whereas the retroreflectors at the periphery or just beyond would be correspondingly less bright. This allows the feedback System to provide fine positioning of the reflected rays from each individual heliostat within the target area of the receiver. Fine positioning of the reflected spot from each of the heliostats avoids overlapping spots that cause ‘hotspots’ on the receiver.

While applicant is aware that some of the known designs have been implemented, it is not known to the applicant whether the known designs have been implemented in a manner leading to an operation of the respective facility that was satisfactory in every aspect. It can however to be anticipated that problems still exist with arrangements according to the prior art. This stems from the extreme adverse conditions met in typical concentrated solar power facilities-obviously, to obtain the high temperatures necessary for a high efficiency of the energy conversion process, it is necessary to concentrate the app. 1 kW/m2 solar radiation irradiating earth must be focused onto a rather small area, leading to both very high power densities and high temperatures. This renders any technical feasible implementation to use modulated retroreflectors very difficult, leave alone a technical implementation that allows particularly good focusing at low costs.

It would be desirable to allow operation of a concentrated solar power facility in a manner providing very high temperatures.

The object of the present disclosure is to provide an improved concentrated solar power facility and methods to operate a concentrated solar power facility.

The object is achieved by the features of independent claim 1. Some of the preferred embodiments can be found in the dependent claims; further preferred features and embodiments are to be found and deduced from the description.

According to a first general idea, a concentrated solar power facility comprising a sun light collector having a sun light collecting area; a plurality of mirrors arrangements for reflecting sun light onto the sun light collector; a plurality of light modulating retroreflectors for reflecting modulated light from the sun light collector back to the mirrors; a plurality of light sensors arranged to receive light reflected back to the mirrors, and to output a light detection signal in response to the reception of modulated light reflected back to the mirrors; a light-signal evaluation stage for demodulating the light detection signal and for generating a mirror adjustment signal light signal; is suggested wherein at least a part of the retroreflectors is arranged adjacent to and in front of or within the sun light collecting area and in the optical path of light concentrated from a plurality of mirrors directed towards the sun light collecting area, is made from a material having low absorption for visible sunlight, is preferably at least temporarily shielded from and/or cooled against thermal radiation from the sun light collecting area and is modulating light with marginal or no absorption.

The disclosure allows for a particularly fast and precise control of the mirror alignment. Placing the retroreflectors right in front of the sun light collecting area, which is heated by the incident solar radiation from typically a vast number of mirrors concentrating solar power onto the sunlight collecting area allows to correct for non-ideal alignments even before the spot from a given mirror leaves the sunlight collecting area or, in cases where a temperature is preferred to not exceed a certain limit, more precisely does not leave an assigned area thereof. Accordingly, there is no need to accept a situation where the reflex from a heliostat first has to leave the central or assigned sun collecting area to determine that the mirror has to be adjusted. As this advantage can be obtained for all mirrors and for all mirrors simultaneously, the incident solar power can be concentrated significantly better, leading to higher temperatures at the sun light collecting area and thus to improved efficiency as well as potential new applications requiring higher temperatures than previously achievable at a given location. A person skilled in the art will understand that obtaining significantly higher temperatures becomes possible only because the disclosure not only provides retroreflectors closer to the central heated area, but also because the specific layout of the retroreflector arrangement prevents damage thereof despite the particularly high intensity of the concentrated sunlight.

It will be understood that rather than placing the retroreflectors in front of the hot zone, it would also be possible to place the retroreflectors directly into the hot zone, depending on the geometry of the heat collecting device. For example, where a number of fluid-guiding tubes with some degree of spatial separation are used to collect the heat and the array of heliostat mirrors is not very wide, retroreflectors might be placed between such fluid-guiding tubes without the risk of shadowing the retroreflectors by the fluid guiding tubes. However, in most cases, it is preferred to place the retroreflectors in front of, but close to the collector so as to avoid any shadowing.

Absorption for visible sunlight is considered low if even given the strong irradiation at the sun light collector, the retroreflector will not heat up in a manner compromising the integrity of the optical elements or their mounts. Given this, the acceptable absorption will vary for different concentrated solar power facilities and for different use cases, but generally, it is safe to consider absorption low if the absorption is below 0,05%, preferably below 0,03% of the radiation between 400 and 1200 nm. In the same manner, light modulation with marginal or no absorption does not require that the material used does not absorb light at all at a given wavelength. However, while inherent absorption of material is inevitable, it should not be increased, in particular not periodically for modulation, so that rather than using absorption for modulation, radiation should be redirected for the purpose of modulation.

Also, as any deviations from the ideal can be detected before becoming too large, rapid-response control signals can be generated. Provided that the mechanical adjustments necessary to correct the mirror position are also sufficiently fast, additional advantages may be obtained, in particular as a less precise but more frequent adjustment becomes acceptable, reducing the costs of actuators needed for the mirror adjustment and for the overall heliostat construction. The increased efficiency also allows to reduce the overall mirror area needed for a given power to be generated, further reducing costs of the concentrated solar power facility. Then, it will be understood that the frequent and precise control of the alignment of all mirrors in the concentrated solar power facility according to the disclosure allows for a less precise initial setup of each single mirror, thus reducing costs.

In this context, it will be understood that while best results will be achieved by controlling all mirrors of the concentrated solar power facility in response to light signals generated when receiving the retroreflected light from the retroreflectors of the present disclosure, it would be possible to implement a concentrated solar power facility where some mirrors/heliostats are controlled in a different manner and/or where additionally, control signals are generated other than in response to light received from the retroreflectors ..

With respect to the heat collectors and the sunlight collecting area, it should be understood that, typically, only one contiguous sunlight collecting area will be provided, for example having fluid tubes running through the area for collecting the incident solar power by heating fluid guided through the fluid. However, it is possible to arrange for a plurality of different sun light collecting areas for example on one central tower with each sun light collecting area receiving light from different groups of mirrors, for example, but not limited to, to have sunlight collecting areas heated to different temperatures. This can be useful where a multipurpose central tower is to be provided, for example when generating both electrical power, energy for production processes and desalinated water. It will be understood that the presence of additional sunlight collecting areas should not be construed to imply that the disclosure is not properly implemented. Furthermore, it might be useful to have a given having different temperature zones, for example a high temperature central zone and surrounding zones of lower temperature; this may be useful in particular for certain chemical production processes, where it is necessary to preheat material prior to transferring it into a reaction zone high temperature. Then, it should be understood that while frequently, fluid will be heated in the sunlight collecting area, it would also be possible to directly heat material to be processed, for example by thermolysis of water to generate “green” hydrogen or to produce cement by solar heat rather than by using a furnace operated with fossil fuels. Also, it might be possible to implement the disclosure in a concentrated solar power facility having a multistage solar radiation concentration arrangement, receiving in a first stage light from the heliostats, and further focusing the light in the second stage onto an area to be heated to particularly high temperatures. For the latter case, the retroreflectors might be arranged in front of the first stage and/or between the first and the second stage and then, the light is focused independently on the second stage.

Where the overall sun light receiving area is divided into a plurality of different sunlight receiving areas with different target temperatures and/or different heat accepting media, it is possible and preferable to divide the totality of mirror units in the facility into a plurality of sub-sets, each containing only a part of the overall number of mirror units and to furthermore steer the heliostats within any given sub-set to direct sunlight onto a specific one of the plurality of different sunlight receiving areas. It will be understood that this helps to prevent overheating and that the assignment of a given mirror to one the different sub-sets may be altered in the course of operation, e.g. when generating both electrical energy and desalinating water, with the amount of water and energy needed changing on a daily, weather dependent basis. In such a case, where the overall sun light receiving area is divided into a plurality of different sun light receiving areas, it is preferred that all different sun light receiving areas are provided with their own retroreflectors and that the modulation of any of the retroreflectors can be distinguished from that of any other retroreflectors. This also allows to assign a given heliostat to a different group by simply instructing the corresponding control of the mirror that the mirror is to be aligned to optimize reception of an altered set of modulation patterns.

It is noted that in such a case, the retroreflectors in other areas, in particular in front of other heat collector areas may act as “border” reflectors provided the corresponding sunlight collecting areas are sufficiently close to each other. Note that generally, placing some (additional) retroreflectors near the (central) reference region such that the additional retroreflectors are close to, but not directly in front of the sunlight-collecting area may e.g. help to characterize the radiant footprint (which is basically corresponding to the intensity profile, albeit when characterizing the radiant footprint, it may already be sufficient to determine whether light is reflected at all to a given location without simultaneously determining the absolute intensity of light reflected to said given location) of the mirrors or mirror segments in a sub-set. Nonetheless, very frequently, intensity information is also easily obtained. As an example, it is possible to modulate the retroreflection by rotating the retroreflector as will be explained in more detail below; now, if modulation is effected by rotating a given retroreflector with a given speed, it can be easily checked whether this given retroreflector receives light from a particular mirror if the respective modulation frequency component is found in the light intensity curve detected with the light sensor assigned to the particular mirror. Such check is simple if a fast Fourier transformation is calculated. However, such fast Fourier transformation not only gives information whether a specific modulation frequency component can be detected in the light received at all, but also allows to determine a strength of the respective frequency component; it will be understood that where a given frequency component in the modulated light is stronger, more light modulated with this component is received and hence the intensity of the retroreflected light is stronger. It will be understood that the same holds in case the retroreflector uses a modulation achieved in a manner different from rotating the retroreflector, although, then, rather than using a fast Fourier transformation, other transformations might be needed. Accordingly, it is possible to not just detect whether light from a given modulated retroreflector is received at all but how much light is received from the retroreflector. Note that such evaluation of the signal strength of modulation frequency components has a number of advantages, even independent of footprint determination. In particular, it can be detected whether the intensity at any given mirror has decreased rapidly which might indicate that a cloud currently blocks the sunlight to the specific mirror. If such information is communicated to other mirrors, e.g. via a central control station, other mirrors can be commanded to supplement the irradiation of the sun light collecting area at that spot of the heat collect the “clouded” mirror was assigned too. Furthermore, when the intensity of a given mirror is slowly decreasing over a long time or is significantly lower than those observed at neighboring mirrors, the mirror might become soiled or might have been damaged and appropriate measures can be taken. However, despite such advantages of evaluating the modulation frequency component strengths, it might already suffice for an improved concentrated solar power facility operation to check whether the intensity of a given modulation frequency component is larger than a specific threshold.

It is possible to perform a characterization for each sub-set separately in a serial fashion, e.g. when intentionally directing a mirror onto retroreflectors adjacent to or bordering the actual target area; such characterization need not be part of a daily or continuous routine but helps in setting up the facility.

It is possible to use a single sensor per mirror or to even use only one single sensor for several mirrors, placing them roughly in the center of a plurality of mirrors. However, modulating each of the plurality of light modulating retroreflectors in a different, distinguishable manner allows to easily distinguish the light reflected back from any single given retroreflector from the light reflected back from other retroreflectors by simply resolving the specific modulation. This can be done easily and without expensive hardware e.g. a photodiode by simply detecting a temporal pattern in the retroreflected light; accordingly, only a simple photosensor such as a photodiode capable of generating an output signal modulated in accordance with the modulation of light effected by the retroreflectors is needed. Thus, it is highly preferred and not very expensive to have at least one light sensor per mirror. In a preferred embodiment, even more than one light sensor per mirror may be provided. This not only creates redundancy, but also allows to determine more precisely any misalignment. The light sensors can be placed right in the center of each mirrors, so that light from the entire vicinity of the sensor contributes to the retroreflected light—this is helpful, because for a perfect retroreflector, the retroreflected light would be reflected back onto almost the exact same spot on the mirror whence it came from with only a minute deviation from there due to the parallel displacement caused by the retroreflector. As the position where a light sensor is placed at or on the mirror does not reflect light towards the retroreflector, any light retroreflected onto the photosensor is received due to imperfections of the optical systems and placing the sensor within and onto the mirror ensured that enough light due to such imperfections can be received. However, while placing sensors right within the mirror area is advantageous for the reasons indicated, placing the sensors at the border of the mirror might still be preferred as this allows for a particularly simple wiring; where drilling holes is to be avoided, it should be noted however, that the light sensors and the light signal evaluation stage for demodulating the light detection signal and for generating a mirror adjustment signal light signal can be combined into a small unit, in particular communication with a central control in a wireless manner e.g. via WIFI, and powered by solar cell. Note that given the decentralized alignment control, a significant part of the data that has to be transmitted for operation of the heliostat array relates to information broadcastable from a central to all or a large number of heliostat mirrors, such as commands to protect the mirror surface against upcoming bad weather conditions and the like.

In this context, it is noted that in the present disclosure, the overall communication between a central control and a heliostat may be extremely reduced as the heliostat will keep its alignment by a local closed loop rather than being aligned only in response to commands received from the central control. The demodulation and determination of correction signals does not require a particularly high processing effort and can easily be effected on a low power computing device. In this context, it should be understood that the typical light signal evaluation stage for demodulating the light detection signal and for generating a mirror adjustment signal light signal will may comprise analog signal-conditioning circuitry such as an impedance converter, amplifier and bandpass filter an will furthermore comprise an A/D converter for converting the analog (conditioned) light detection signal into a series of digital values. The frequencies used in audio processing will typically be sufficient to provide for oversampling of the analog light detection signals typically modulated with frequencies way below 20 kHz; also, the resolution can be as low as 16, 14 or even 12 bit. The time series of digital values can then easily be subjected to processing steps such as fast Fourier transformation to check whether certain modulation frequencies or groups of certain modulation frequencies can be found with an amplitude sufficient to warrant detection of a correspondingly modulated light signal—and to derive mirror adjustment signals where necessary. As all this requires little computational effort and little power, and alignment and as calculations are necessary only during daytime so power can be provided using local photovoltaic solar cells. For example, it is possible to use cheap digital signal processors (DSPs) readily available for the processing and signal evaluation.

In this manner, no wiring would be needed, in particular as control signals to actuators could be transmitted either in a wireless manner as well or via the central control. Note that the communication with the central control needs to be infrequent, e.g. for transmitting the correct modulation patterns where different groups of mirrors are defined, for transmitting a command to move the mirror into a safety or park position in view of upcoming bad weather and so forth. Also note that it is possible to prepare the mirror in the evening prior to sunset for the next day by moving it into a predefined sunrise position and/or by moving it into a sunrise position altered in view of a current adjustment signal.

In the above, it has already been mentioned that actuators will be provided and used to orient the mirrors according to light signals received. These actuators for aligning the heliostat mirrors will typically be electromechanical actuators, but basically, any actuator that can be properly controlled and sufficient for the loads will be suitable for the purpose of the present disclosure. Where full advantage of the high-speed closed loop control of mirror alignment afforded by the present disclosure is to be made, the actuators will be capable of moving the mirrors rather rapidly. However, given typical dimensions of concentrated solar power facilities, with distances possibly exceeding 1 km between a single heliostat mirror and the heat collecting area, and further given the size of the sun disk in the sky, the overall area onto which a mirror reflects light is rather large so even if part of a reflection moves partially over the border of a heat collecting area due to the movement of the sun, a major part of the light reflected by a given mirror will remain within the light collecting at least for some time, so that moderate alignment speeds will typically be sufficient in view of the fast onset of correction provided by the present disclosure.

It will be understood that most frequently, a set of adjustment correction parameters for adjusting at least two angles of the mirror will be determined, but where the mirror has an adjustable focal length, a third parameter for focal length correction may be determined as well if the heliostats are provided with focal length adjustment actuators. In this context, determining corrections of the focal length can be done e.g. in view of the size of a mirror spot which in turn could be determined either by a sufficiently large number of irradiated retroreflectors or by scanning the reflection of the heliostat over a few retroreflectors in a known manner.

Regarding retroreflectors, two types of retroreflectors may find use for the present disclosure: the first type is the so-called corner-cube retroreflector (CCR) and relies on three successive reflections of light from three reflective surfaces set at right angles to each other. These may be front-surface mirrors in a so-called hollow-cube retroreflector, or the interior surfaces of a glass prism shaped as a truncated corner of a cube. In the latter case, reflection may occur due to mirror coatings on the outsides of the reflective surfaces, or due to total internal reflection (TIR). The second type of retroreflector, also know as ‘cat-eye retroreflector’ (CER) uses a piece of transparent material such as glass with two semi-spherical surfaces, spaced from each other such that light entering through one, first, such surface, and refracted at it, is focused onto the interior side of the other semi-spherical surface, from whence part of the light is reflected due to the refractive-index contrast. This reflected light is then re-collimated on the first semi-spherical surface and returned to its source. Due to spherical aberrations, the returned light is slightly divergent. The spacing between and the radii of curvature of the two semi-spherical surfaces are related to each other through the refractive index n of the glass or other transparent material. In the special case of n=2, the cat-eye retroreflector is simply a sphere.

Using either type of retroreflector, the modulation can be effected without relying on absorption of light. Instead, Light can be redirected rather than absorbing it.

In the case of a corner-cube retroreflector, modulation can be achieved by making it rotate about an axis that is not coincidence with, and preferably perpendicular to, the optical axis defined by the symmetry axis of the three reflective surfaces. From the point of view of a light source, light directed towards such a rotating retroreflector will be returned exactly to the source as long as, during a rotation period, the entrance face of the retroreflector is facing roughly towards the source, and will not be directed anywhere near the source when, during the rotation period, the entrance face is turned away from the source. In this latter case, the light is not absorbed, but rather refracted into well-defined directions, which are different from the direction of the source and therefore irrelevant here.

As an alternative and/or in addition, the reflectivity from a corner-cube reflector based on total internal reflection can be modulated by frustrating the total reflection, i.e., using an effect that taps into the evanescent wave on the outside surface of at least one of the reflective surfaces, so that light leaks away from it instead of undergoing total internal reflection. Such a light leak can be controlled through physical proximity of a material with a suitably high refractive index, or by controlling the reflective index of a material filling a gap between said reflective surface and another higher-index material.

Where a cat-eye retroreflector is used, it is also possible to fashion parts of a semi-spherical or, in the case of n=2, fully spherical surface with disturbances such as scratch lines, laser-written patterns, etc. and to then rotate the retroreflector. The pattern provided on the surface will have only a minor optical effect when facing towards the light source, i.e., while it is part of the entry/exit surface; however, the pattern will have a severe impact on the reflectivity from a focus on the other surface: light from a focus encountering an undisturbed part of the (semi-)spherical surface will be reflected as described above, but light from a focus encountering a surface disturbance will be mostly scattered instead of being returned to the source. Therefore, if the body with the semi-spherical surfaces (or fully spherical surface for n=2) is rotated, and the interior focus encounters the disturbances, retroreflection is interrupted and so any spatial pattern of disturbances is turned into a corresponding temporal modulation of the retro-reflection.

While it is possible and significant advantages can already be obtained if a single one of the plurality of retroreflectors is arranged adjacent to and in front of or within the sun light collecting area and in the optical path of light concentrated from a plurality of mirrors directed towards the sun light collecting area, additional advantages can be obtained if more than a single retroreflector is placed as suggested by the present disclosure. Placing a plurality of retroreflectors allows to determine the form of the light spot reflected by a given heliostat mirror onto the sunlight collection area. This 2-dimensional intensity profile that any given mirror leaves on the target can be referred to as a “radiant footprint” and may have rather irregular forms due to e.g. mechanical distortions of mirror surfaces and optical errors. Thus, it is preferable to determine the radiant footprint and, where possible, to align the mirror in a manner improving the radiant footprint. The respective measurements can frequently be effected for all mirrors simultaneously, including both segmented and non-segmented heliostats, i.e., where each heliostat has a single segment.

Regarding the material of the retroreflectors, as well as of any devices associated therewith, e.g. for holding them in the correct position, it will be understood that while the maximum temperature in a concentrated solar power facility would correspond to the surface temperature of the sun, approximately 5780 K, the temperatures actually achievable strongly depend on the thermal properties of the materials used. In particular, while a direct heating of material to be processed, for example when producing cement, allows for very high temperatures, where a fluid is heated, the temperature of fluid guiding tubes and the like are limiting factors. This is important for the retroreflectors as well as the maximum useful temperature to be achieved in the sunlight collecting area also determines the maximum temperatures to which the parts of the retroreflector arrangement will be subjected. Even where solar power is used for processing material by direct irradiation thereof, temperatures will hardly exceed approximately 1500 °C to 1750 °C.

Now, the mechanical elements associated with the retroreflectors will typically comprise at least mounting elements for positioning the retroreflectors right in front of the sunlight collecting area; where the retroreflectors modulate light by a mechanical movement e.g. a rotation of the retroreflector, further mechanical elements might be necessary to transmit a driving torque, although the retroreflectors could be mounted on a spindle driven by a motor outside the light collecting area. Some of the mounting elements might be placed outside the sun light collecting area and thus can be kept at lower temperatures, but what has to be kept in mind is the typical size of the sun light collecting area which in a midsized to large concentrated solar power facility has an extension of e.g. up to about 20 m×20 m. This will lead to significant overall thermal expansion and care should be taken to not strain the retroreflectors mechanically due to such thermal expansion. Where a retroreflector or a plurality of retroreflectors are mounted on a spindle or held by such spindle, it is advisable and preferred to mount the spindle in a manner allowing for an extension. Also, the materials used should withstand the heat without significant deformation-preferred materials for ultra-high temperature applications include tungsten, high temperature suitable ceramics, and quartz glass. Such mounts should preferably reflect light, in particular both in the visible spectrum of incident sunlight and in the range of the thermal radiation coming from the sun light collecting area. This can be achieved by choice of material and/or by use of appropriate coatings.

Also, it is highly preferred to mount the retroreflectors inside a housing, or arrangement, which is transparent to sunlight, and has a backside shielding the retroreflectors from the IR radiation of the heated sun-light collecting area at least where the retroreflectors are positioned. It is possible and preferred to use a tubular housing for the retroreflectors and to position the retroreflectors on a spindle inside the housing. This allows in particular to blow air through the tubular housing for cooling, strongly reducing the strain on material if the air flow is sufficient which in turn can be achieved using a sufficiently large tubular diameter. Therefore, this is preferred. Note that where air flow through the tubular housing is used for cooling, it would be possible to also use it for driving a retroreflector movement (rotation), e.g. by coupling one or more fans, turbines, etc. to the central axis or spindles held by a central axis. Note that such rotation of each retro-reflector will be effected about an axis not coincident with and typically perpendicular to the optical axis if the retroreflector, so that the entrance window periodically is facing towards and away from the mirrors This gives a very simple way to drive the retroreflectors and often, it is even possible to drive a multitude of retroreflectors coaxially arranged in the tubular housing in a manner giving a different modulation for each of the retroreflectors. Such different modulation can be achieved e.g. by frustrating total internal reflection differently for different retroreflectors such that different modulation patterns are achieved and/or by loosely rotationally coupling the retroreflectors to a central axis (that is, rotatable against the central axis) and allowing for a different rotational speed by a combination of air driven rotation and friction specific for each retroreflector. With respect to a tubular or other (transparent) housing cooled by air, it is noted a double walled housing can be implemented, which reduces stress on the material further.

One of the preferred materials for the retroreflectors themselves-that is, the optical elements actually retroreflecting the sunlight-currently is quartz glass. Furthermore, much or all of the supporting mechanical components, such as mounts, rotational-drive mechanism, etc., can advantageously be made from quartz glass. With its high optical transmission, the glass will then let almost all of the incident sunlight, typically more than 99.95%, pass through and onto the sunlight collector, while being heated only to a minimal extent by sunlight absorption. Corner-cube retroreflector made from quartz glass are easily available and can be used up to app. 1100 °C. Furthermore, quartz glass has a low thermal expansion, which is an advantage given the high temperature variations it will be repeatedly subjected to in use. Due to the high transmission in the visible and adjacent parts of the optical spectrum, the quartz glass will mainly heat up by being subjected to the thermal radiation emitted by the hot surface of the sun light collecting area. Thus, for using quartz retroreflectors and ancillary components in the immediate vicinity of the sun-light collecting area even if heated to the high temperatures achievable with the present disclosure, it is sufficient to block the retroreflector against the thermal radiation coming from the sunlight collecting area. As indicated above, where such heat shield is provided, it may be sufficient already to only shield the retroreflector rather than shielding an entire cooled housing. Depending on the specific use case, it will not absolutely necessary to provide a heat shield, although in most cases, the better concentration of sunlight that the present disclosure provides will lead to very high temperatures if too much of the concentrated light is absorbed by the retroreflectors or parts of the retroreflector arrangement such as the drive mechanism for rotating the retroreflector or at least those parts of the drive mechanism that are placed directly in front of the collector or at least close to it. Note that given the typical size of a sun light collecting area, the drive mechanism may comprise a spindle several meters long; it may be preferred to support such a spindle at both sides, e.g. the above the upper edge of the sun light collecting area and below the lower edge thereof. However, in particular where the heat is collected by heating fluid guided in tubes, the retroreflectors and their drive mechanism might be attached to a wall of the tower between the fluid guiding tubes. This increases the thermal load but allows for smaller retroreflector arrangements.

It should however be noted that the preferred material for the retroreflector and/or the shielding may depend on the specific use case of the concentrated solar power facility. For example, where electric energy is to be produced, it might be preferable to keep the temperatures of the solar light collecting area surface significantly below 1000 °C, because otherwise, extremely hot fluid would have to be processed and handled resulting in excessive additional costs e.g. when retrofitting a concentrated solar power facility rather than to just increase efficiency. In such a case, typically, no heat shield would be needed. This enables, in particular, the use of retroreflectors made of a material with lower temperature tolerance than quartz glass, such as refractive material with n=2 in the case of cat-eye retroreflectors .. The surface of such retroreflectors can be locally altered e.g. by scratching, etching, laser ablation or the like to generate a pattern in the reflectivity of Fresnel reflection from the interior surface opposite to that of light entry. Rotation of a sphere prepared in this manner will then produce a corresponding temporal pattern in the retro-reflected light.

As the present disclosure allows for a rapid, closed loop or closed-loop like control of the mirror alignment, it is not necessary to fully optimize mirror alignment when placing a mirror in a field of heliostats, e.g. when constructing a concentrated solar power facility, when replacing or repositioning a heliostat e.g. after a repair or maintenance, when re-aligning mirrors following a cleaning procedure thereof or when severe wind gusts have caused misalignment. Because alignment and, optionally, focusing of each mirror can be calibrated rapidly by use of the retro-reflectors, a mirror can quickly regain a lock on the collector, i.e., proper pointing of the reflected sunlight onto the assigned collector. The swift re-alignment allows, in particular, to place and only roughly align mirrors, using e.g. a mobility platform, i.e., a mobile apparatus onto which a respective mirror is mounted or with which it can be transported to an operating position within an array of heliostats. Such a mobility platform may be equipped with a computer or microprocessor to control its motion, preferably using a wireless-communication equipment for coordination with a central control computer of the facility from which instructions on where to move are received, e.g. in order to avoid collisions with obstacles such as other mirror units. Each mirror or mobility unit may also contain means to determine its position within the facility, which may be GPS receivers, radio or sound receivers for measuring distances and directions relative to radio or sonar beacons distributed within the facility, or radio or sound emitters whose emissions are detected by receivers distributed within the facility, or optical navigation by landmarks in or near the facility, or some other means of navigation. The mobility platform may also comprise local power generation and/or storage for its own operations, for example based on photovoltaic cells and/or batteries. A power supply might also comprise cables being dragged along with the motion, or means to plug into power receptacles distributed throughout the facility.

If mobility platforms are used, each mirror may be fully mobile or may be moved and placed and then left stationary so that the mobility platform can be used for another mirror. It is noted that the method of rapidly correcting for any misalignment according to the disclosure is extremely advantageous when using a mobility platform and that a method of operating a concentrated solar power relying on the modulation of light retroreflected from a position in front of and close to the solar power collecting area offers additional advantages when a mobility platform as described above is used; however, it will be understood that where other suitable methods of correcting mirror alignment are available, the use of mobility platforms as described is advantageous per se and applicant reserves the right to claim such a mobility platform and/or its use in an independent manner, in particular independent of e.g. the modulation of retroreflected light and/or the placement of retroreflectors. Also, as can be seen above, a mobility platform can be easily used to facilitate cleaning or other periodic maintenance of the mirrors by moving them to a central service station within the facility. During the build-up phase of a facility, this station may also serve as a factory to produce mobile mirror units. Furthermore, shelters distributed throughout the facility may allow mirror units to move to protection in the case of inclement weather or other conditions of danger to the mirror units. Once serviced, or once the hazardous conditions are over, the mirrors move back to assigned positions and re-acquire lock onto their assigned collectors. Again, it is noted that such method may be claimed in an independent manner, albeit specific advantages are obtained in combination with the present disclosure.

In a preferred embodiment, it is additionally suggested that the light sensors are positioned close to or within the reflecting area of the respective mirrors. As discussed above, this is advantageous in particular where retroreflectors cubes are used as these are typically of very high quality leading to very low deviations from an ideal retroreflection with only a slight parallel displacement as then, the entire vicinity around the light sensor will contribute to received retroflected light. Also, the chances that the area around the sensor is in the shadow of another mirror for some time during the day due to inadvertent placement of the respective heliostats is significantly reduced when placing the light sensor in the center of the mirror or at least sufficiently far away from the border. Also, the sensor is typically protected better against mechanical damage in the center than at the border.

It will be understood that a multi-segment heliostat may comprise more than one sensor, that one sensor can be shared among a plurality of mirrors and that even a single mirror heliostat may have several sensors, e.g. for the purpose of providing a certain redundancy. Where multiple sensors are provided per heliostat, it may be sufficient to have only one signal evaluation stage and to use it serially for all sensors on the mirror. A particularly advantageous case of providing several receivers for a single heliostat is given for heliostats having a plurality of independently adjustable mirror “facets”.

Using the disclosure with facetted mirrors is advantageous in that a method for controlling the overall pointing of heliostats can be implemented where the detailed alignment of the mirror facets in a heliostat is effected by closed-loop feedback using samples of sunlight reflected by the respective facets of the heliostats onto the collector and each facet mirror of the heliostat receives retroreflected light pertinent only to itself, i.e., derived only from the light reflected by the very facet mirror onto the collector. Thus, the samples of sunlight will be in the form of light reflected back towards each respective facet mirror of each heliostat. These samples will be easily distinguishable from each other—and hence from facet to facet and from the general bright background of the collector by the modulation of the sunlight retroreflected to each facet. It would even be possible to not just rotate a retroreflector, but to add a “wiggle” to its rotation so that it is easier to sample and differentiate irradiation from certain directions and/or to alter the modulation pattern.

It will also be understood by a person skilled in the art that the photosensors employed will be sufficiently fast to follow the modulation; while many digital image sensors (DIS), such as CCDs or CMOS sensors may not be capable to follow at least the higher modulation that can be employed here, it would also be possible to use digital image sensors that can be read out fast enough or that allow to read out regions of interest at high speed, thus allowing use of such sensors which is a particular advantages for simultaneously detection the sun and at least one retroreflector simultaneously in an wide angle image—in this manner, no mechanical movement when observing the sun position would be necessary.

In a further preferred embodiment, it is alternatively and/or additionally suggested that the photosensors in a concentrated solar power facility comprise a photodiode or a PSD and circuitry adapted to detect a modulation in the range of up to at least 0.1 Hz, preferably up to at least 1 Hz, preferably in particular at least 10 Hz, further preferably in particular at least 100 Hz and in particular at least 1 kHz.

The modulation can thus be made significantly faster than most mechanical actuators will react. Regarding the time constants associated with mechanical actuators, a very slow modulation will typically be sufficient, e.g. with up to 0.1 Hz. This results in an extremely low computational effort; however, higher modulation speeds are preferred, in particular, where modulation is achieved using rotating retroreflectors because modulation frequencies can then separated better from naturally occurring frequencies such as wind-induced vibrations, optical disturbances, passing clouds, etc.. Also, rotating a retroreflector faster means that where the frontside temperature and/or irradiation differs strongly from the backside temperatures and/or irradiation, a periodic changing gradient across the retroreflector is reduced. Furthermore, somewhat faster modulation speeds are usually preferred by the persons adjusting electronics.

With rotational speeds of about 1 Hz, preferably between at least 1 Hz and at least 10 Hz, the heat problem is resolved. Still higher frequencies such as 10 Hz or above will improve adjustability of circuits and will also help to detect wind gusts and the like, even if no adjustment are made in response to such detection.

Using a modulation frequency (or distinctive modulation frequency components where each modulation comprises more than one single modulation frequency e.g. due to a corresponding pattern for frustrating total internal reflection) above 50 to 100 Hz may be particularly useful where a large number of different retroreflectors need to be distinguished, e.g. in cases where different target temperature zones are defined in the sunlight collecting area. Again, even frequencies of about and more than 100 Hz can easily be processed without a particularly powerful data processing unit.

Where modulation frequencies higher than 100 Hz are used and achieved by driving the retroreflector, the support and/or rotational drive must be suited to the correspondingly high rotational speeds. Speeds higher than that may require increasing effort without further advantages unless a very high number of retroreflectors need to be distinguished and/or an attempt is made to acquire additional information that might not be necessary for aligning the mirrors but helpful in understanding operating conditions of a given concentrated solar power facility e.g. because of wind gusts, clouds asf.. Using sufficiently high modulation frequencies is also advantageous where the number of retroreflectors that need to be distinguished is high.

Where light modulation is effected by rotating one or more retroreflectors, the pertinent modulation frequencies can be centrally determined (e.g. by setting a respective rotational speed) and transmitted from a central to the respective heliostats using WIFI or other broadcast means. Note that it would be sufficient to transmit information to the heliostats relating to only the coarse modulation frequency band of a given retroreflector rather than the current actual modulation frequency, because a check for frequency components in the respective coarse modulation frequency band can be easily made after e.g. an FFT of a conditioned and digitized light reception signal. Also, informing the heliostats only about certain modulation frequency bands reduces the overall need for communication between a central and the heliostats because otherwise, a more frequent transmission would be needed e.g. because of jitter. As the modulation bands should be sufficiently distinct, it is easy to keep a retroreflector rotational speed for modulating the retroreflected light within said band, allowing for some drift and jitter.

It will be understood that in certain cases, rather than using a discrete FFT of a conditioned and digitized light reception signal, it would also be possible to use analog bandpass filters or the like.

In a further preferred embodiment, it is alternatively and/or additionally suggested that the light sensors comprise a digital image sensor (DIS), in particular a CCD or CMOS as well as a lens for simultaneously observing the sun and the retroreflectors and that the light signal evaluation stage is adapted to determine an overall orientation of the mirror relative to the sun.

Determining an overall orientation to the sun is helpful for a number of reasons. For example, when placing a heliostat in an array of heliostats, it is preferable to place it such that alignment can be achieved with the given range allowed for by the actuators-making optimum use of this range is more straightforward when position of the sun during placement is known. Also, it is possible to predict shadowing effects caused by other heliostats and or for other heliostats. Additional advantages and improved control can be obtained e.g. when observing whether the sky is clouded using the DIS. It will be understood that in a sufficiently wide angle image acquired with the DIS, the (single spot) sun can be easily distinguished from a resolvable multitude of retroreflectors close to each other and spaced apart from the sun. Thus, an overall orientation can be determined using the DIS.

Note that where the modulation is particularly slow and/or the digital image sensor or regions of interest (ROI) therein can be read out at a high rate, it would be possible to use a series of digital image sensor (DIS) images to obtain the modulated light signal.

It should also be understood that in front of the digital image sensor DIS and/or in front of a photodiode, appropriate spectral filters could be provided so that for example, a bright sky contributes less to background noise, and that neutral density filters could be provided so that only the brightest light sources and hence the sun and/or the retroreflectors contribute significantly to a signal.

In a further preferred embodiment, it is alternatively and/or additionally suggested that the mirrors focus light onto the light collecting area in an adjustable manner and the light signal evaluation stage is adapted to determine a quality of focusing of light onto the light collecting area, in particular in view of the signals from a plurality of retroreflectors. To this end, it must not just be determined that a given heliostat is directing light onto a given retroreflector, but a more precise evaluation of the light intensity profile is needed. This can be achieved e.g. by either providing a plurality of light receivers on a single mirror, thus “segmenting” the mirror into a plurality of distinguishable areas or segments. Another way of obtaining said radiant footprint information relating to a current distribution would be to move the mirror in a manner such that the reflection thereof “scans” over a given area, in particular an area where the density of retroreflectors, in particular a line density orthogonal to the direction of scan movement is higher than in other light reception areas. Note that turning the mirror towards such region of high retroreflector line density may result in additional optical errors of imaging achieved with a focusing mirror and that therefore, it is preferred to have the area over which the light reflected from the mirror should best be placed within the actual sun light collecting area thus reducing the excursion needed for scanning. Note that evaluating the intensity profile of a heliostat reflection are also helpful in determining whether certain mirrors have been damaged, e.g. during sand storms, or have become soiled to a degree justifying a cleaning thereof even prior to the scheduling of a regular cleaning (if regular, periodic cleanings are part of a regular maintenance scheme). It is noted that it would be possible to obtain footprint information by directing the reflected intensity to one or more retroreflectors positioned outside of the “hot” collector zone, that is outside the sunlight collecting area, so use of detecting the radiant footprint information and improving the overall irradiation pattern in response to such information can be made even when no retroreflector is placed adjacent to and in front of the sunlight collecting area. Applicant reserves the right to claim such use of radiant footprint information in a manner independent from the features of the main claim as pending when filing this application and in particular reserves its right to file one or more divisional patents to protect said idea which is considered inventive per se.

It is possible and preferred to transfer modulation related information to the light signal evaluation stage for demodulating the light detection signal and for generating a mirror adjustment signal light signal; to this end, the current or target modulation frequency for all retroreflectors can be transmitted to each light signal evaluation stage.

In a further preferred embodiment, it is alternatively and/or additionally suggested that the collector surface is provided with a coating highly absorptive at visible and near-infrared wavelengths and highly reflective at the far-infrared wavelengths. Providing a highly reflective coating at the far-infrared wavelengths implies that the respective surface also has a low emission so that consequently, the hot collector has a low emission at the wavelengths where hot collector would emit most of the heat, thus reducing the thermal load of the retroreflector. Far IR for the purpose of the present disclosure can be defined as wavelengths beyond 2 μm. A coating is considered highly reflective for the purpose of the present disclosure if at least 5% preferably 10% and preferably at least 15% improvement over an uncoated surface is achieved. Also, coating is considered highly absorptive if at least 5% preferably 10% and preferably at least 15% improvement over an uncoated surface is achieved. The coating should be highly absorptive at visible and near-infrared wavelengths as there, most of the radiant energy is incident. Reducing the amount of the light energy that is reflected instead of being absorbed not only improves the efficiency of the arrangement but also reduces the thermal load on the retroreflectors. Thus, such coating contributes to the potential increase of operating temperatures that become possible due to the better alignment. It should be noted that it is possible to define different temperature zones on the sunlight collecting area and to coat only a part of these zones, e.g. where a zone so hot is needed that coatings are not durable enough. Note that it is in particular possible to provide different heat zones on different sides of a central light collection tower and/or at different heights thereof.

In a further preferred embodiment, it is alternatively and/or additionally suggested that at least some of the retroreflectors are placed in one or more reference regions close to or in front of the collector. It should be understood that the reference zone can be different from the heat collecting area onto which the sunlight or the vast majority of the sunlight is focused. The reference zone can for example be placed close to the border of the heat collecting area which is helpful during an initial set up as it is easy to align the mirror from such known position even if this position is not within the actual target zone. Also, use of reference regions allows to have a retroreflector free zone where particularly high temperatures are to be achieved. In the latter case, the reference regions can still be in front of and adjacent to the sunlight collecting area, but spaced apart from the zone of highest temperatures. Note that being placed in the path of the optical path of light concentrated from a plurality of mirrors directed towards the sun light collecting area implies for the purpose of the present disclosure that the irradiation sunlight intensity is above 100 kW/m2, typically above 200 kW/m2, more preferred is at least 300 kW/m2 and may easily exceed 500 kW/m2, with the different intensities mentioned depending on how close to the sunlight collector the retroreflectors are placed. In a typical setup, the intensity of the sunlight at the place of the retroreflector will exceed the 500 kW/m2 mentioned and may be even larger than 750 kW/m2, reaching to the typical values of about 1 MW/m2 in currently operated concentrated solar power facilities.

As stated and explained above, it is possible to place the retroreflectors in one or more cooled housings. Thus, in a further preferred embodiment, it is alternatively and/or additionally suggested that the retroreflectors are contained in one or more cooled housings having highly light-reflective or highly transmissive, but not absorbant, walls and/or a heat shield between the reflector and the collector to protect the retroreflector from radiant heat due to concentrated sunlight directed towards the collector and/or due to the (infrared) heat radiation from the collector. Note that using a gaseous cooling fluid is typically preferred as the refractive index of gases or gas mixtures such as air is close to 1 and a total internal reflection of a corresponding retroreflector will not be disturbed. Cooling the retroreflector may be particularly useful where the retroreflectors or their optical elements respectively are not made of quartz glass or are not made entirely of quartz glass as is the case for retroreflecting spheres with refractive index of n=2. It might be sufficient to use a quartz plate arranged in the tube or outside thereof as a shield, but materials other than quartz might be used as well for shielding and/or for the mounts and other non-optical elements. For example, high temperature ceramics could be used for shielding. Note that the aforementioned slight divergence of retro-reflected light from a cat-eye retroreflector may be advantageous, as it will result in the photosensor receiving retroreflected light not just from the small mirror area in the immediate vicinity of the photosensor, but also from mirror areas more distant from the photosensor.

In a further preferred embodiment, it is alternatively and/or additionally suggested that the retroreflectors are provided with a defocusing lens arrangement on the entrance/exit window of each retro-reflector. As has been stated above, the standard corner-cube retroreflectors are rather precise optical elements, up to the degree where the sensing of light is impaired. Here, a defocusing lens, in particular obtained by suitably polishing a retroreflector entrance/exit window might help to spread the retroreflected light and ensure that detection of the retroreflected light at the heliostat is not impaired by the perfection of the retroreflector cube. Where a defocusing lens on each retro-reflector or each of a plurality of retro-reflectors is used, it should be defocusing to such a degree that it slightly spreads the back-reflection over an area the size of a mirror segment, so that samples of light reflected by any part of the respective mirror segment and back by the retro-reflector reach the photosensor on or by the respective mirror segment.

Providing a defocusing lens arrangement by suitably polishing the entrance/exit window rather than using a separate element is helpful because the retroreflector arrangement will then be more stable even under extremely adverse operating temperature conditions.

As has been stated before, it is alternatively and/or additionally suggested that retroreflectors using total internal reflection are used and the total internal reflection is frustrated for some entrance angles so as to provide for a modulation of the retroreflected beam. Also, such frustration of the total internal reflection can be achieved by scratching lines or scattering (etched or roughened areas at the reflecting sides). Note that scratching is particularly preferred as this allows to provide a characteristic modulation pattern for each retroreflector, in particular for both retroreflector cubes and retroreflecting spheres as usable with “lower” temperatures of about 700 °C.

Another possibility to allow for the modulation of retroreflected light is to place an electrically or electromagnetically controlled absorber or reflector, for example a liquid-crystal light modulator (LCLM) or other type of electro-optic modulator inside of the retro-reflector or in front of the retroreflector, in particular directly onto its optical aperture.

The retroreflector arrangement can in certain instances be retrofitted to existing concentrated solar power facilities in order to obtain a concentrated solar power facility according to the present disclosure. Therefore, protection is also sought for a retroreflector arrangement adapted for use in a concentrated solar power facility as claimed, the retroreflector arrangement in particular being adapted in certain embodiments for such use in that it comprises a plurality of retroreflectors that are adapted to be arranged adjacent to and in front of the sun light collecting area and in the optical path of light concentrated from a plurality of mirrors directed towards the sun light collecting area, and in that they are made from a material having low absorption for visible sunlight, being provided with a shield for at least temporarily shielding from and/or cooled against thermal radiation from a sun light collecting area of a heat collector of the concentrated solar power facility and in that they are adapted to modulate light with marginal or no absorption. By using the retroreflector arrangement of the present disclosure, an optimal reflection geometry can be maintained where heliostats periodically re-locate themselves, so that the angle between the optical axis of each respective mirror and the incoming and out-going sunlight is as small as possible, i.e., where the re-flection geometry is as close as possible to back-reflection. In this geometry, optical aberrations are minimized and the cross section of the beam of captured sunlight is maximized. Because of the apparent motion of the sun on the sky in the course of each day, the mirrors need to move around to always be on the opposite side of their assigned collectors, relative to the sun. This method makes use of the capability of mirrors to rapidly re-acquire lock after moving. In a similar manner, heat collectors may also and or alternatively be mounted on mobility platforms to move them into optimal alignment with mirrors.

It will be understood that the light modulation is considered to be effected with marginal or no absorption under the same conditions as stated above. Therefore, protection is also sought for such retroreflector arrangement.

It will be understood that in a preferred embodiment, the retroreflector arrangement may comprise a rotating or otherwise modulated retroreflector as disclosed above together with suitable mountings, although a person skilled in the art will understand in view of the disclosure in its entirety that other ways to implement a retroreflector arrangement according to the disclosure exist and can be implemented.

Furthermore, when retrofitting existing concentrated solar power facilities so as to obtain a concentrated solar power facility according to the present disclosure, a light sensor arrangement might be needed which is adapted for such use, in particular in some embodiments in that the light sensor arrangement comprises a plurality of light sensors arranged to receive light reflected back to the mirrors and to output a light detection signal in response to the reception of modulated light reflected back to the mirrors; the light detection signal being adapted to be put into a light signal evaluation stage for demodulating the light detection signal and for generating a mirror adjustment signal light signal.

Therefore, protection is also sought for such light sensor arrangement

It will be understood that a concentrated solar power facility as claimed can be operated in that the reflectivity of the retro-reflectors is based on total internal reflection and is modulated by altering the efficiency of the total internal reflection, in particular by at least one of altering the width of a gap between a total internal reflection-active surface and a matching surface of a piece of a material with a refractive index greater than unity or and/or by altering the refractive index within a gap between a total internal reflection-active surface and a matching surface of a piece of a material with a refractive index greater than unity.

It should be understood that modulating the reflectivity of a retroreflector can e.g. be effected by rotating a retroreflector about an axis other than its optical axis, i.e. a surface normal to its optical aperture. Different modulations for different retroreflectors can easily be achieved by choosing different rotational speeds for every retroreflector. Due to the rotation and in accordance with the rotational speed, there will be both time intervals when light from a mirror segment will strike the entrance aperture its detailed orientation and time intervals when the entrance aperture is facing away from the mirror segment so that the retro-reflector cannot—reflects any of the light from that mirror segment back. It should also be understood that therefore, the retroreflector will at all times either back-reflect to a mirror segment, or not back-reflect at all. This is different from e.g. a lighthouse beam sweeping continuously across the horizon. It is interesting to note that in the transition period between reflecting and non-reflecting, only a part of the retroreflector will participate in retroreflecting incident light. Thus, the signal will have leading and trailing edges defined by the form of the entrance aperture, which may even be used in distinguishing different retroreflectors, e.g. by altering the edges of an entrance window.

In a preferred way of operating a concentrated solar power facility according to the disclosure, multiple retro-reflectors are placed within a reference region, with the reflectivity of each retro-reflector being modulated such that a unique temporal signature is obtained and the signals from all retro-reflectors received by each photosensor are separated in view of this unique temporal signature, e.g. by correlating the received with the respective modulation signal, as known per se from lock-in techniques. This technique then also samples the radiant footprint from each mirror at each location of a retro-reflector. Such information allows to not only correct the orientations of the mirror but also e.g. focus errors where the focus of the mirror can be adjusted.

As is obvious from the above disclosure, it is possible and preferred to operate a concentrated solar power facility in a manner where the alignment of heliostat mirrors is controlled using a control loop generating control signals in response to modulated light retroreflected directly received from the sun light collecting area, that is the hot—or rather hottest—part of the sun light collecting area and not just the border thereof which may be irradiated due to misalignment at best.

It will be understood furthermore that various methods exist to improve the spatial resolution achievable with retroreflectors according to the disclosure. For example, while it would be possible to increase the resolution by increasing the number of retroreflectors within a given target area, another way to improve the spatial resolution achievable with retroreflectors would be by scanning the location of one or more retro-reflector(s) across the reference region to obtain radiant footprint information serially within the scan, yet simultaneously for all mirror segments. The spatial resolution of such a scan is better than that from the mere discretization of the reference region obtained only by the fixed number of retro-reflectors itself. Furthermore, by scanning the angular alignment of one or more mirror units in a manner moving the radiant footprint across one or more retro-reflector(s) within the reference region allows to obtain the footprint Information serially within the scan, yet even simultaneously for all mirror segments.

### BRIEF DESCRIPTION OF THE DRAWINGS

The disclosure will now be described in more detail, but by way of example only with respect to the drawings. In the drawings, what is shown by the respective figure is:

FIG. 1 illustrates a model of a concentrated solar power facility with mobile heliostats;

FIG. 2 illustrates mobile heliostats with adjustable focus;

FIG. 3 illustrates two mirrors reflecting sunlight onto a reference region where a retroreflector reflects some of the light back to the respective mirror;

FIG. 4a illustrates an imperfect mirror reflecting diverging rays, thus creating an extended radiant footprint at the reference region with the retroreflectors (here 2) in different locations within this footprint all reflecting diverging rays back towards the respective mirror while also doing the same for any other mirror (as shown in FIG. 3);

FIG. 4b illustrates the footprints from a plurality of imperfect mirrors as seen on the sunlight collecting area and retroreflectors arranged there;

FIG. 4c illustrates a visualization of scanning movements for determination of the footprint pattern of imperfect mirrors;

FIG. 4d illustrates a plurality of placement options of retroreflectors for footprint determination for different forms of heliostat mirror arrays around a central tower;

FIG. 5 illustrates a retro-reflector (here in two dimensions) in different phases PI . . . P6 of its rotation about an axis perpendicular to the graph plane, where in phases PI . . . P3, an incident light ray is back-reflected with constant pointing into itself and in phases P4 the incident light is not reflected at all, so that the back-reflection will, in the course of the rotation, be periodically modulated;

FIG. 6 illustrates a retro-reflector in front of the sunlight collector back-reflecting light to two mirrors, which are directing sunlight towards the collector, with the retro-reflector rotating about an axis other than its optical axis and thus modulating the back-reflection;

FIG. 7 illustrates the overall intensity of light retroreflected from a plurality of retroreflectors and a schematic of an arrangement for distinguishing the light coming from different retroreflectors;

FIG. 8a illustrates a spherical retroreflector using a material refractive index of n=2;

FIG. 8b illustrates a spherical retroreflector using a material with refractive index of n=2 and having a plurality of scratch lines going thru a pole for frustrating retroreflection;

FIG. 9 illustrates the overall intensity of light retroreflected from a plurality of retroreflectors using a modulation different from that shown in FIG. 7 and a schematic of an arrangement for distinguishing the light coming from different retroreflectors;

FIG. 10 illustrates retroreflector with added interference filter in front thereof;

FIG. 11 illustrates a sketch of a photosensor movable in an eyeball-like manner;

FIG. 11b illustrates a sketch of another photosensor arrangement;

FIG. 11c illustrates a sketch of yet another photosensor arrangement;

FIG. 11d illustrates an array of photosensor arrangements as shown in FIG. 11c;

FIG. 12a illustrates a first embodiment of a rotating retroreflector arrangement;

FIG. 12b illustrates a detail of the FIG. 12a embodiment;

FIG. 12c illustrates another detail of the FIG. 12b embodiment;

FIG. 12d illustrates a second embodiment of a rotating retroreflector arrangement;

FIG. 12e illustrates a detail of the FIG. 12d embodiment.

### DETAILED DESCRIPTION OF THE PREFERRED EMBODIMENTS

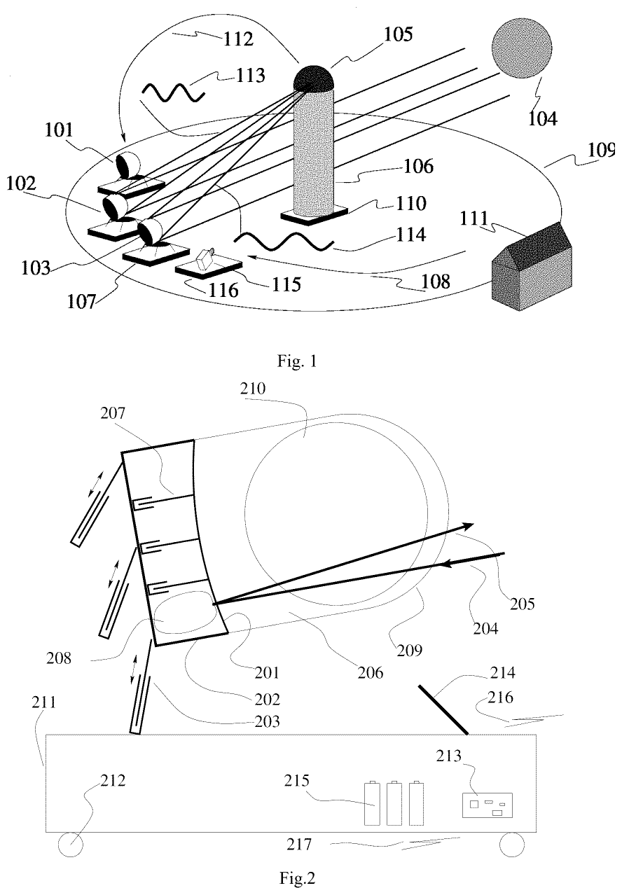

In FIG. 1a, a general setup for a concentrated solar power facility is shown. In the present disclosure such concentrated solar power facility comprises a sun light collector having a sun light collecting area; a plurality of mirrors arrangements for reflecting sun light onto the sun light collector; a plurality of light modulating retroreflectors for reflecting modulated light from the sun light collector back to the mirrors; a plurality of light sensors arranged to receive light reflected back to the mirrors and to output a light detection signal in response to the reception of modulated light reflected back to the mirrors; a light signal evaluation stage for demodulating the light detection signal and for generating a mirror adjustment signal light signal; wherein at least a part of the retroreflectors is arranged adjacent to and in front of the sun light collecting area and in the optical path of light concentrated from a plurality of mirrors directed towards the sun light collecting area, is made from a material having low absorption for visible sunlight, is at least temporarily shielded from and/or cooled against thermal radiation from the sun light collecting area and is modulating light with marginal or no absorption. Note that in certain circumstances, some or all retroreflectors might also be arranged directly within the sunlight collecting area; these reflectors would still be in the optical path of light concentrated from a plurality of mirrors as they are at the end of such path directed towards the sun light collecting area.

Turning now once more to FIG. 1a in more detail, a mirror unit 101, a mirror unit 102 and a mirror unit 103 each direct light from the sun 104 onto a collector 105 atop the tower 106.

In FIG. 1, only three mirror units are shown but the person skilled in the art will understand that a typical concentrated solar power facility may comprise hundreds or thousands of such mirrors arranged around the tower. In the embodiment shown, each mirror unit, such as mirror unit 103, is mounted on a mobility plat-form 107, which allows free motion 108 on a field 109. Optionally, tower 106 bearing a collector 105 may also be mounted on a mobility platform 110, which allows it to relocate on the field 109 or to set up a solar power facility as a transportable unit wherever large amounts of power need to be generated for some time, such as when erecting buildings at a remote place. Furthermore, there may be multiple towers with or without mobility platforms distributed within or near the field (not shown).

In the case of multiple collectors, the mirror units are at least temporarily assigned to specific ones thereof which can be done according to an optimization procedure for the entire facility.

A maintenance shop 111 or a plurality of maintenance stations is situated on or near the field 109 for mirror units to visit for periodic maintenance or repairs. The maintenance shops can also serve as a factory for producing mirror units during buildup of the facility, or for replacement of worn-out or damaged mirror units during operations. In the embodiment shown, the mirror units can position themselves as they are mobile, so they can be placed optimally with respect to the sun 104 and with respect to the collector 105 atop the tower to which they are directing the sunlight to, so that the angles of incident and reflected sunlight relative to each mirror axis are minimized, and optical aberrations thus mitigated. However, in other embodiments, such mobility is not necessary and mirrors and their alignment devices can be kept at a fixed position in the field.

However, whether mobile or not, the mirrors have to keep directing sunlight onto their assigned collectors, even while moving on the field 109, or at least after moving to a given position. Given the diurnal movement of the sun across the sky, according to the present disclosure, the pointing and in certain instances the focusing of each mirror is controlled in a feedback loop which is schematically referred to with reference sign 112. Using the feedback loop, the contribution of each mirror unit to the light reaching the respective collector 105 is analyzed or it is at least determined whether the contribution needs to be amended by realignment and hence, corrective information is provided by the feedback loop 112 to the respective mirror unit 101 so as to allow for adjustment of its pointing and, where applicable, its focusing.

The feedback loop is active at least during a part of the day to periodically correct the motion of the otherwise free-running actuators and in certain instances, other controls on the mirror units. In order to discriminate the contribution of each mirror unit to the entirety of light reaching a collector, the light is labeled by way of modulation using retroreflecting elements; such modulation may refer to wavelength-spectral features, temporal modulation of the intensity or a combination of both; in particularly simple implementations, only a temporal modulation is provided.

This will be explained in more detail hereinafter but is also indicated in FIG. 1a, where the light received at mirror unit 102 is modulated at a frequency f2 as shown by reference sign 113 whereas light retroreflected by a different retroreflector is modulated at a frequency f3 indicated by reference sign 114, and which, in the figure, is lower than the frequency shown at 113.

Optionally, an infrared-reflecting, yet shorter-wavelength-absorbing coating may be applied to the collector 105 which, by the Einstein coefficients of thermal absorption and emission, proportionally reduces the infrared emission. This coating has two purposes: The first is to reduce thermal emission losses, i.e., better utilizing the collected radiant power reaching the collectors in the shorter-wavelength, i.e., mainly visible, parts of the spectrum. The second purpose is relevant for implementations of the disclosure where the suppression of thermal emission reduces the background and thermal load on the retroreflectors as will be understood hereinafter. Coatings that preferentially enhance infrared reflection, while maintaining a high degree of shorter-wavelength absorption, have been developed for multiple purposes, including architectural ones. The latter offer robustness in open-air operation, which is relevant for solar-energy collection.

Turning now to the heliostats for more detail, in particular the heliostats that are mounted on a mobility platform, FIG. 2 shows a schematic cross section of one mirror unit with a mirror 201 mounted on a support structure 202 which, to implement the mobility platform, may move autonomously or may be moved by a drive unit temporarily attached. The mirrors may be directed by pointing actuators 203. The reflective side of the mirror 201, i.e., the side on which the sunlight is incident 204 and from which it is reflected 205, may be protected from the environment by an enclosure 206. The opposite side of the mirror is a ‘non-reflective’ side. The mirror in the embodiment shown is a focusing mirror 201 having adjustable focus and the focusing properties may be controlled in several ways, examples of which are given here. These examples are meant for illustrative purposes only and are not to be understood to constrain the scope of the preferred embodiment relating to mirrors allowing for focal adjustment. Such preferred embodiments may encompass any means of adjusting the focusing properties of the mirror 201. One type of focusing adjusters comprises motor-driven screw actuators 207. Another way of adjusting the focal properties of the mirror relies on flexing of the mirror and is based on differential pressure between the inside of the enclosure 206, i.e., on the reflective side of the mirror 201 and a different overall pressure on the non-reflective side, causing the mirror to flex. More detailed control of the mirror shape can be obtained with several independently pressure-controlled gas-filled bags 208 pushing on the non-reflective side. Yet another way of Controlling the focal strength of the mirror unit is based on control of the gas pressure, and thus the refractive index inside the enclosure 206 in conjunction with a curved, for example hemispherical shape of a dome 209 on the outward-facing side of the mirror unit. This refractive effect is independent of focusing due to pressure-induced flexing of the mirror and may be used additionally or alternatively to it.

The preferred embodiment may include a variant where the mirror is entirely contained inside the pressurized volume, so that there is no flexing, and where all of the focusing power is due to the refractive effect on the dome 209. However, in order to achieve a significant refractive index, rather high gas pressures are required, exceeding cost-effective engineering options for the enclosure 206. An alternative Option is to place a gas volume with curved surfaces, such as a balloon 210 inside the enclosure 206, which then acts as a gas lens with a pressure-controlled refractive index. The spherical shape of the gas lens is meant as an example only, and the embodiment shall comprise any gas volume with curved surfaces used as a variable lens through control of the pressure internal to it. A good way of achieving high and variable densities for a strong refractive effect is to use a gas with a critical point near ambient conditions. Examples are ethane with a critical temperature Tc of 32.2 °C and a critical pressure pC of 49 bar, or carbon dioxide with Tc=31.1 °C and pC=73.8 bar. These two gases are meant as examples only, and the disclosure shall comprise the use of any gas near its critical point. Other components in a mirror unit include: the mobility platform 211 on wheels 212 or other means of providing mobility, a control computer 213, local power generation and storage, for example with a small photovoltaic module 214 and batteries 215, wireless Communications 216 with a local-area network for the entire facility, or wireless Communications 217 with local antennas built into the facility platform to enable more targeted and secure Communications.

As stated above, retroreflectors are used in the present disclosure with the retroreflection being modulated. Therefore, now, the use of retroreflectors will be explained in more detail.

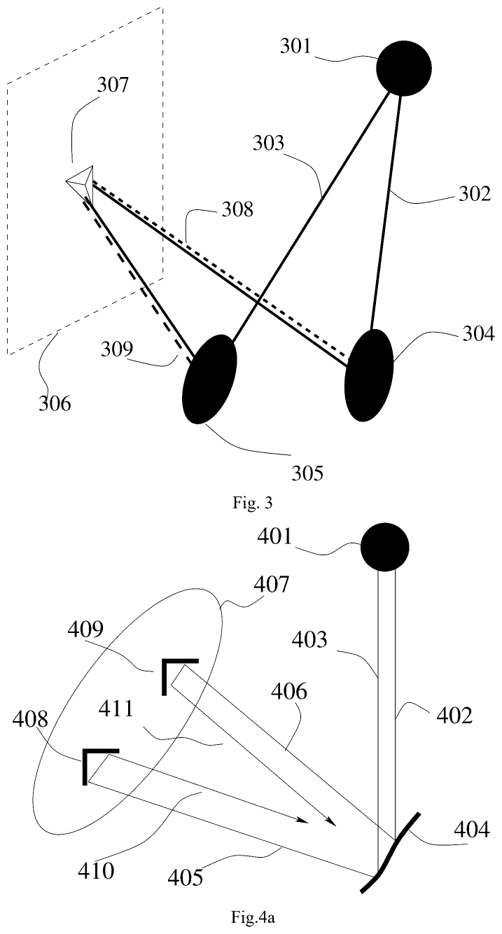

FIG. 3 shows a schematic overview of a main feature of the disclosure where light from the sun 301, represented by a first ray 302, and a second ray, 303 is reflected by a first mirror 304 and a second mirror 305 towards a reference region 306, which may be partially or fully in front of, integrated into, or near the sunlight collector, and where one or more retro-reflectors 307 simultaneously back-reflect the first rays 308 towards the first mirror 304 and second ray 309 towards the second mirror 305.

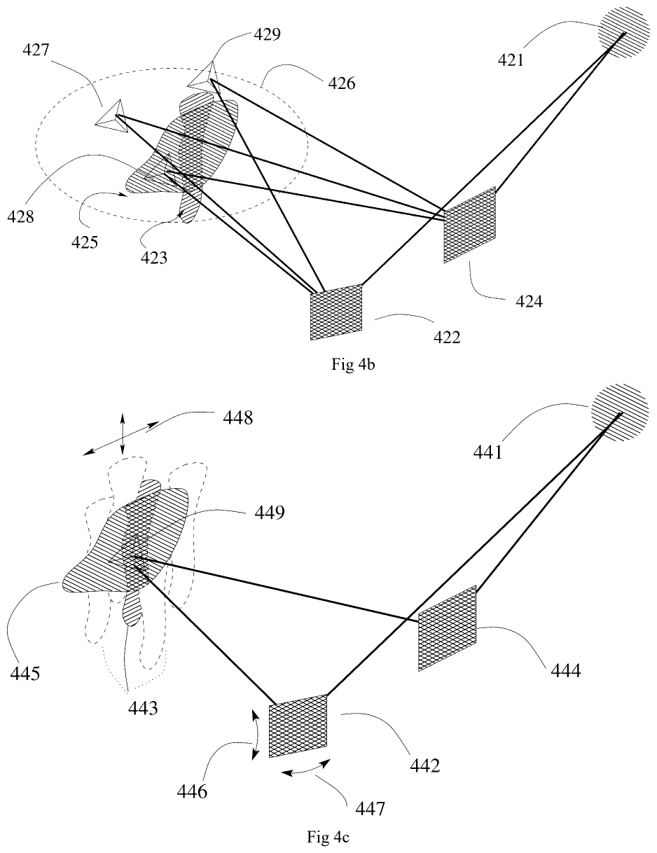

In FIG. 4a, two retroreflectors are shown right in front of the heat collecting area and thus within the path of concentrated sun light, receiving light from at least 10, preferably at least 50 and typically more than 100 mirrors in operation and hence irradiation densities of more than 10 kW/m2, typically even more than 50 kW/m2 and preferably even above 100 kW/m2. The retroreflector will be so close to the heat collecting area that at least for a large number of mirrors, retroreflected light is only received if the mirror also directs its light onto the heat collecting area. Given the sometimes oblique angle of incident, this requires the reflector to be not more than 10 m in front of the heat collector front surface, typically less then 5 m in front of the heat collector front surface and typically at a distance of no more than 2 m from the heat collector front surface. It is advantageous to have the retroreflectors as close to the heat collector front surface as possible, so typically, distance may be as low as 1 m or below. Note that space must be allowed for a housing, drive units and so forth, imposing a minimum gap requirement. In more detail, FIG. 4a shows light from the sun 401 incident as a first ray, 402 and as a second ray 403 on a mirror 404 whence they are reflected, due to an imperfect mirror-surface figure, under diverging directions as reflected first ray 405 and reflected second ray 406 towards the reference region 407 where, all such rays from mirror 404 collectively form a radiant footprint of that said mirror.

That radiant footprint may have a somewhat irregular shape due to a nonperfect shape of the mirror 404, as indicated in the figure by its wavy shape. The light rays shown in the figure are back-reflected by a first retro-reflector 408 and a second retro-reflector 409 as back-reflected first ray 410 and back-reflected second ray 411, respectively, towards the same mirror 404. The radiant footprints from a plurality of imperfect mirrors reflecting light onto the sunlight collecting area are shown by way of example in FIG. 4b for the radiant footprints 423 and 425 from two heliostat mirrors 422 and 424, both reflecting light from the sun 421 onto the same region 426 containing retroreflectors 427, 428, and 429.

It is not absolutely vital or necessary to determine the footprint of a given heliostat mirror. Therefore, any method and devices for footprint determination are considered optional. However, even though not vital, it may still be helpful to determine the geometry of the footprint, for example to determine whether certain heliostat mirrors are excessively warped, whether they need an adjustment of the focal length or, preferably, how such adjustment should be effected. To this end, retroreflectors can be used in several ways. A first way to determine the geometry of the footprint is to determine retroreflections across the sunlight collecting area using retroreflectors in a plurality of locations, and to determine for each location the intensity of light (including none) retroreflected from it to the respective heliostat. For a sufficiently precise measurement this may require a rather large number of locations and hence retroreflectors, contributing to the complexity of the overall design. Another possibility would be to move a retroreflector across the sunlight collecting area. If this is done in an unconventional manner such as using a drone, the position of the drone must be communicated to the respective heliostat mirrors. Another possibility is to use a retroreflector movably mounted at the central tower, although the mechanical arrangement will be complicated and expensive and a current retroreflector position must also be communicated to all respective heliostat mirrors. Therefore, a particularly preferred way of footprint determination is to scan the mirror across the heat collector by altering the alignment angles and to determine for a plurality of scanning angles the retro-reflected intensities from the retroreflectors already there. There are several disadvantages associated with such a method. This method might require that some mirrors in an array undergoing such a footprint check might direct all or a major part of their reflected light to an area different from e.g. a central target zone. Also, focusing mirrors will typically have some sort of optical imperfection such as spherical aberrations and such imperfections will vary with the angle of incident light-however, if a specific incident angle is needed at a specific time so that the heliostat mirror directs its reflection into a target zone, the scanning method suggested necessitates that the alignment angle and hence also the angle of incidence is changed, resulting in an altered spherical aberration pattern. Nonetheless, such changes to the spherical aberration pattern or other errors due to a scanning motion will typically be negligible compared to the overall imperfections of a heliostat mirror, even if facetted. Then, the fact that for a limited time during a scan, light from said heliostat mirror is not directed at the preferred target will also be negligible for the operation of a standard concentrated power facility typically having a large number of mirrors such as several hundreds or thousands of mirrors. On the positive side, it should be noted that the entire scanning and evaluation can be effected decentralized, greatly simplifying the overall operation. Therefore, in FIG. 4c, an arrangement is shown where light from the sun 441 is reflected by heliostat mirrors 442 to create a radiant footprint 443, while light reflected from heliostat mirror 444 is creating a radiant footprint 445 a radiant footprint 445. The two mirrors, 442 and 444, represent a much larger plurality of such mirrors in an actual facility. If, now, mirror 442 is moved in a scanning manner by systematically changing the two alignment angles 446 and 447 using their respective actuators, then the radiant footprint will move, 448, across the collector area and, specifically, across the retroreflectors contained therein, such as the one 449, shown in the figure. Regarding the information on the shape of radiant footprint 443, this is equivalent to scanning the retroreflector 449 across the footprint 443, as both will provide an intensity profile of said radiant footprint in the form of the retroreflected light in dependence on the scan parameters, i.e., angles 446 and 447.

In the context of footprint pattern determination, it is also noted that several options exist to place heliostat mirrors around a central tower and that different ways of retroreflector placement can be used for footprint determination. FIG. 4d depicts several of these options. Shown on the left side of FIG. 4d is the placement of one or more retroreflectors in a reference region 461 below the collector 462, both on a tower 463; a batch of mirrors 464 steers sunlight onto the reference region 461 where one or more retroreflectors 465 are situated. Meanwhile the other mirrors reflect light onto the collector 462 (where additional retroreflectors for keeping the reflected light in the central hot zone may be arranged in front of the sun light collecting area as described in this document). In the center of FIG. 4d, retroreflectors (with only one, 466, being shown) are arranged in front of the collector and rays from all mirrors are directed towards the collector while alignment is characterized with only such retroreflectors—this will be sufficient for a sufficiently large number of retroreflectors in front of the sunlight collecting area, e.g. because different temperature zones need to be defined within the sunlight collecting area or because the number of mirrors is so large that overheating of the heat collector structure by inadvertently directing light reflections of too many mirrors onto the same target area must be avoided. At the right side of FIG. 4d, several retroreflectors 467 are arranged around the collector, seen from heliostats within a limited angular range relative to the collector; one mirror 468 is severely misaligned and receives a back-reflected signal 469 from the retroreflector to the left of the collector. Note that the later retroreflector arrangement is not only helpful to determine the footprint of heliostat mirrors but also to have an initial rough estimate of misalignment when placing a new or repaired heliostat into an existing and working heliostat array.

These different configurations allow for different ways of operation. By designating a reference region close to the sunlight collector, and periodically steering batches of tens to hundreds of heliostats by a few mrad to direct sunlight onto the reference region, characterizing the radiant footprint of all mirror segments in all heliostats of one batch simultaneously becomes possible; batch sizes are limited mainly only by the heat tolerance of the retroreflectors. Accordingly, the period for repeating a footprint determination can be short, typically limited only by balancing an improved focusing by repeated adjustment of the footprint against some loss of efficiency because a given mirror will not participate in heat generation during the scan operation.

When performing the footprint characterization simultaneously for all heliostats of the facility with retroreflectors in front of the sunlight collector itself, the retroreflectors obviously need to withstand the full heat load due to the incident sunlight, but the present disclosure teaches how this can be achieved. Such a configuration allows continuous simultaneous feedback control of heliostat and may be advantageous if a sufficient number of retroreflectors can be provided.

Then, placing retroreflectors in the perimeter of the collector (as shown on the right side of FIG. 4d) which would then receive sunlight from heliostats only within a limited angular range from the collector; this keeps the retroreflectors out of the full heat, but still allows simultaneous monitoring of all heliostats in operation; however the information may be less detailed than in the other options, the heliostats can be situated only within a limited angular range from the collector, and the retroreflectors are only ‘trip-wires’ to catch significant mirrors faults in the collector area.

Note that the first two options could be implemented with a single retroreflector being scanned across the pertinent area, or with several retroreflectors whose back-reflections that are disambiguated by intensity modulation or other light-labeling techniques. The second option requires modulation even with a single retroreflector in order to make the back-reflection stand out against the bright scattered sunlight from the collector. The third option inherently uses several retroreflectors. Due to the limited angular range of heliostat placement, it is most suitable to locations within a valley or other geographic constraint oriented roughly in the north-south direction.

All three options allow characterization and correction of heliostats footprints under operating conditions, using the sunlight itself. As heliostat figure (footprint) inaccuracies show large diurnal variations, e.g. due to diurnal thermal cycling, it might be advantageous to characterize mirrors repeatedly at different times of the day. With the first option using several retroreflectors, all heliostats in a batch can be characterized within about a minute, i.e., the time required to steer the heliostats by a few milliradians to the reference region, acquire samples of the footprint of each mirror segment of each heliostat simultaneously for all mirror segments and in simultaneously shapes of the footprint, and then steer back to the collector. With a batch size of 100, the 10000 heliostats of a typical facility can then be processed within less than 2 hours, i.e., allowing characterization multiple times a day. With a single retroreflector, the first option may take a somewhat longer to allow for scanning the retroreflector across the reference region. The second option with several retroreflectors works continuously on all heliostats; depending on the details of the modulation scheme used for disambiguation, reaction times can be less than a second to about a minute, thus allowing for inexpensive heliostat mounts and actuators with limited mechanical stability. In option 3, the response is also almost instantaneous, but providing less or less precise detail than the second option. Nonetheless, it still allows the use of rather inexpensive mounts and actuators and still obtain both good alignment and footprint control.

It will be understood by a person skilled in the art that the determination of the radiant footprint can be used to improve the operation of the concentrated solar power facility in a variety of ways. If suitable actors are provided as per se known e.g. from large astronomical telescopes, warping of the mirrors could be corrected and could be corrected locally. However, this requires additional controlled actuators and might not be preferred due to the additional hardware needed. Another possibility would be to determine the radiant footprint for different positions and use any given mirror to reflect light into that part of the sunlight collecting area where the “best”—i.e. smallest—radiant footprint would be obtained. Then, a check could be made whether the quality e.g. size of the radiant footprint of a given is significantly worse than the radiant footprint obtained by other mirrors, which might indicate that the specific mirror is particularly warped and might be damaged. Furthermore, as the radiant footprints obtained from different heliostat mirrors are expected to show noticeable variations from heliostat mirror to heliostat mirror, efforts could be taken to optimize not the specific radiant footprint of each single heliostat mirror but rather to obtain an overall irradiation pattern of the solar light collecting (hot) zone. To this end, once a mirror has finished determination of its radiant footprint, the pattern observed can be transmitted to a central control center common to all mirrors or all mirrors of a group of mirrors. It will be understood that even for a large number of mirrors such as several 10.000 or even 100.000 mirrors in a concentrated solar power facility and a rather large number of retroreflectors used for determination of the radiant footprint, the overall amount of data to be communicated will remain small quite small. In the central control center common to all mirrors or all mirrors of a group of mirrors, a best alignment for each mirror or a plurality of some mirrors can then be calculated by evening the overall irradiation intensity on the sunlight collecting area in view of the radiant footprint patterns. The corresponding alignment for all mirrors can then be determined.

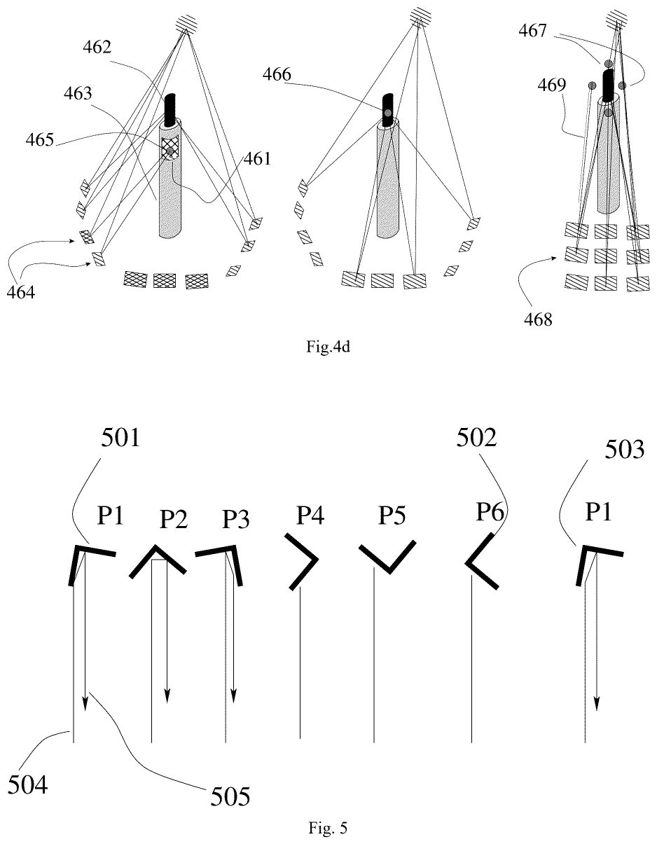

FIG. 5 shows one possibility of modulating the reflectivity from a corner-cube retro-reflector, namely by rotating it. This is a modulation method particularly easy to implement. In FIG. 5, a retro-reflector, for the sake of graphical simplicity in two dimensions, is shown in different phases during one turn of its rotation, namely phase P1 01 to phase P6 502, and again in phase P1 303. An incident ray 504 is returned in a constant direction opposite to the incident light as a back-reflected ray 505, but only during rotation phases PI . . . P3 when it hits the reflective side of the retro-reflector, i.e., within the legs of the ‘L’ denoting a retro-reflector. During the other rotation phases, P4 . . . P6 in the graphic, the incident light does not hit a reflective surface, and is thus not returned to the respective mirror segment. Under continuous rotation, this results in a periodic on-off modulation of the light back-reflected from the retro-reflectors.

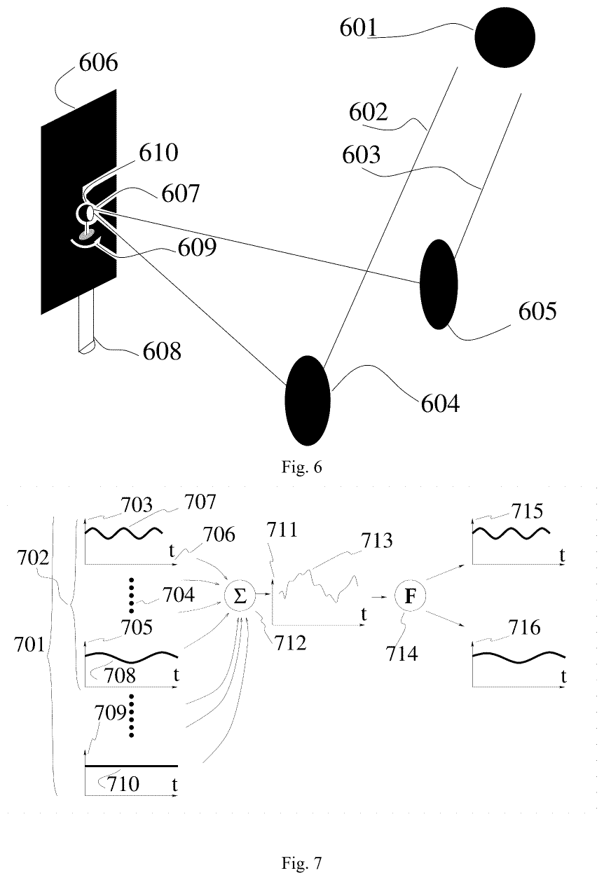

As shown in FIG. 6, this modulation occurs for light incident from all directions onto the retroreflector. Accordingly, it is possible to use the same retroreflector for a plurality of different mirrors. This is shown by way of example in FIG. 6, although it will be understood that in practice, a very large number of heliostat mirrors (rather than only 2 as depicted in FIG. 6) will irradiate the solar light collecting area. It will also be understood that FIG. 6 is for explanatory purposes only, namely for showing that a retroreflector properly positioned as suggested is useful for controlling alignment of many, typically all heliostat mirrors. It will also be understood that a plurality of retroreflectors as shown will be arranged in the path of concentrated sunlight, in front of and adjacent to the sun light collecting area heat as described shall be used for the purpose of this disclosure. Now, in more detail, FIG. 6 shows light from the sun 61 as a first incident ray 62 and a second incident ray 63 reflected respectively by a first mirror 604 and a second mirror 605 towards the sunlight collector 606. A retro-reflector 607 is placed on a support 608 in front of the solar light collector 606 and within the region illuminated by all heliostat mirrors of the facility. Accordingly, the retro-reflector 607 is arranged in the optical path of light concentrated from a plurality of mirrors directed towards the sun light collecting area. Furthermore, it may be placed not only in front of the sun light collecting area, but also adjacent to it in that the distance between the surface of the sun light collecting area—as for example defined by the closest part of tubes guiding fluid to be heated by the concentrated sunlight is a small compared to the linear extension of the sun light collecting area in a given direction. Typically, the distance between the closest part of tubes guiding fluid or other physical surface will be less than 25%, typically less than 10% of the distance and preferably less than 5% of the linear extension of the sunlight collection area. For example, where the sunlight collection area has an area of 20 m×20 m, the retroreflectors will be spaced from the sunlight collection area no more than 5 m, preferably less, e.g. 2 m or even only 1 m. Note that there, the solar irradiation will be highly concentrated, but that all correctly adjusted heliostat mirrors will reflect light onto the retroreflector and will receive light from the retroreflector. Also, note that as the retroreflection is obtained from the area where heat is collected, the control of alignment is significantly improved over a situation where retroreflectors are placed on the side of the sunlight collection area only, resulting in a greater deviations of heliostat mirrors. The retro-reflector is made to rotate as indicated by arrow 609 on its support 608 in order to modulate its reflectivity by rotation as illustrated in FIG. 5, thus allowing to distinguish the light back-reflected by the retroreflector to the mirrors from other light e.g. from the sky or scattered from the collector, or light back-reflected by other retro-reflectors rotating at different rates. In some designs, the retro-reflector 607 could be left without shielding from the light coming towards the sunlight collector, because, due to the transparency of the retro-reflector material, only a small fraction of that light is absorbed by the retro-reflector. However, the retro-reflector 607 may need to be protected by a back-side shield 610 from long-wavelength infrared light emitted by the hot sunlight collector.

As has been stated above, in the disclosure, a plurality of retroreflectors retroreflecting modulated light to the heliostat mirrors will be used. For example, a square pattern could be used where the sun light collecting area is a square or close to a square. The retroreflectors could be arranged e.g. in a 2×2 array of retroreflectors, but an array with more retroreflectors such as a 2×3 or 3×3 pattern might be preferred because that allows to detect a beginning misalignment early on. Where several heat zones are to be defined in the sunlight collecting area or certain groups of heliostat mirrors are to be assigned to different parts of the sunlight collecting area, the number of retroreflectors obviously might be even larger.

The different retroreflectors might be modulated differently by different means. Probably the method both most simple to implement and most simple to understand is to provide physically identical retroreflector cubes and to rotate each such retroreflector cube with a different rotational speed. Other methods might imply to add some precession to the rotation which would periodically alter the retroreflection, thus adding additional frequency components.

FIG. 7 relates to the reception of light from a plurality of retroreflectors each modulating the respective retroreflected light with a different modulation frequency. In more detail, when receiving light simultaneously from a plurality of retroreflectors as would be the case with a well-aligned heliostat mirror and retroreflectors placed sufficiently close to each other so that they are simultaneously irradiated by the sunlight coming from a given heliostat mirror, the light retroreflected by the different retroreflectors will be superimposed on the receiver of that heliostat.

In FIG. 7 schematically shows an example of a modulation scheme for an array comprising a total number T 71 of retroreflectors, in the Figure represented by a subset 72 all irradiated by a given heliostat mirror and additional retroreflectors 79 not illuminated by said given heliostat mirror. Each retroreflectors is placed right in front of the sun light collecting area and is modulated by rotation with a different rotational speed leading to different temporal patterns of intensity for each retroreflection as indicated by reference sings 703, to (704) 705 and, finally, 709 showing modulations over the time axis 706 at different frequencies as indicated by 707 and 708. Note that as no light is irradiated onto retroreflectors 709, the intensity coming from this direction is constant; it is however different from zero, as background light from the area around the retroreflector, which area might be brightly illuminated by other heliostat mirrors, is received at the light receiver 72. Thus, at the light receiver 72 retroreflected light is superimposed resulting in an intensity 711 curve over time as depicted in 713. The corresponding light reception signal can be conditioned such as impedance converted, amplified and bandpass-filtered and digitized. Thereafter, a fast Fourier transform (FFT) can be effected as shown by 714, and the respective modulation components 715, 716, and so on, can be identified thus identifying from which retroreflector light is received. From this, a correction signal for re-aligning the heliostat mirror can be easily determined, keeping the heliostat mirror reflection in a desired target zone.

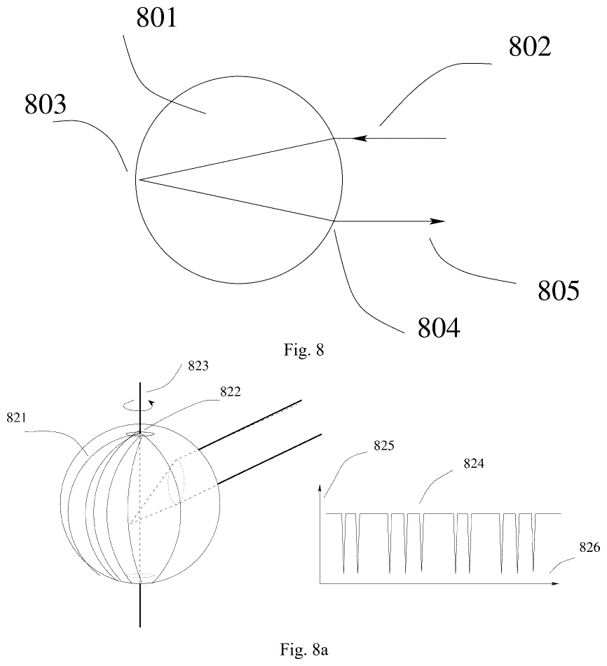

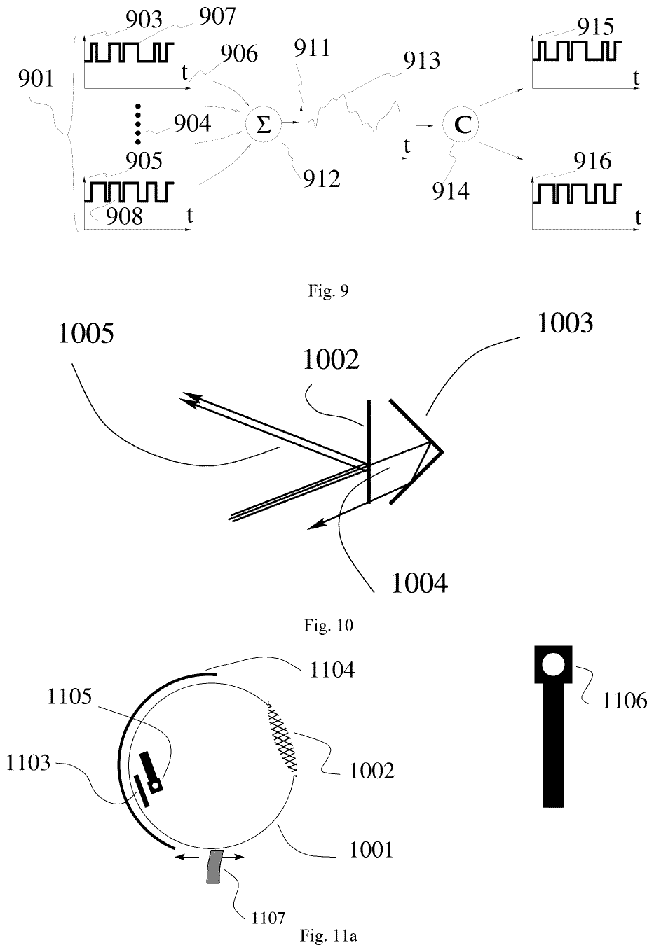

It will be understood by a person skilled in the art that modulation may not just rely on rotation of a corner-cube retroreflector. Another possibility will now be explained with respect to FIGS. 8 and 9.

FIG. 8a shows a sphere 801 made from a material having a refractive index of n=2. Such a sphere will retroreflect light incident falling into the sphere from any direction
because an incident light ray 802 will be refracted at the spherical surface onto a focus 803 common to all such rays (save for spherical aberrations), and situated on the spherical surface opposite to the side where the ray entered. Due to the refractive-index contrast at that surface, a sizeable fraction of the light is reflected, hits the spherical surface at location 804 where it is refracted into a direction 805 opposite the incident one.

Now, the surface of the sphere can be modified e.g. by scratching lines 821 or grooves into it, e.g. several lines all passing through a pole 822. When a sphere modified in this manner is rotated around the pole, a light ray 823 will be retroreflected as explained in FIG. 8, such that the focus 803 may fall on an undisturbed part of the spherical surface or a line or groove 821 In the former case, retroreflection occurs almost as shown in FIG. 8, except for some scattering losses due to the lines on the entry surface. However the retroreflection will depend strongly on whether the focus 803 hits a line/groove or not. If the sphere rotates about an axis 823 going through the pole 822, lines/grooves 821 will move through the focus 803, and the spatial pattern of lines will be translated into a corresponding modulation 824 of retro-reflected intensity 825 over time 826. Accordingly, the light retroreflected in this manner will be modulated. This is shown in FIG. 8b. The modulation frequency or frequencies will depend on the one hand on the rotational speed of the sphere and on the other hand on the modification pattern. Note that a similar effect can be achieved by placing a reflective material onto certain areas of the surface of the sphere such as along a plurality of lines all passing through a pole.

Accordingly, it is possible to have more complex modulation patterns. In particular, a set of mutually orthogonal binary sequences (BINS) could be employed, for example pseudo-random sequences, similarly to the CDMA technique widely used in digital radio communications such as cell phones. However, unlike in digital-radio communications, no further data need to be included in the modulation, as only the channel-identifying function of the BINS is needed. The BINS are preferably chosen such that, while satisfying the orthogonality requirement, they optimize use of the modulation-frequency spectrum to minimize interference from other influences on the intensity on the collector, such as due to atmospheric turbulence, mirror vibrations, etc. A scheme of an arrangement is shown in FIG. 9. FIG. 9 closely corresponds to the arrangement shown in FIG. 7, but instead of a modulation in terms of certain frequencies, a more complex modulation by a set 901 of mutually orthogonal binary sequences, sequence 907 to (904) sequence 908 of retro-reflected intensities 903 (for sequence 907) to 905 (for sequence 908) over time 906 could be provided. Evaluation of the sum 912 signal 913 of received intensity 911 over time basically corresponds to that shown in FIG. 7 and explained with respect to FIG. 7, but instead of an FFT of the digitized light reception signal, scalar products in the abstract vector space spanned by the BINS are determined as indicated by the calculation stage with reference sign 914, resulting in extraction of demodulated signals 915 or 916. Note that both the calculation of the scalar products or the FFT can be easily effected using low-power DSPs.

It should be understood that while above, reference was had to a sphere made from material of n=2, material with a refractive index different from n=2 could be used with a design which is similar although it would then not be spherical which must be taken into account with respect to the modulation.

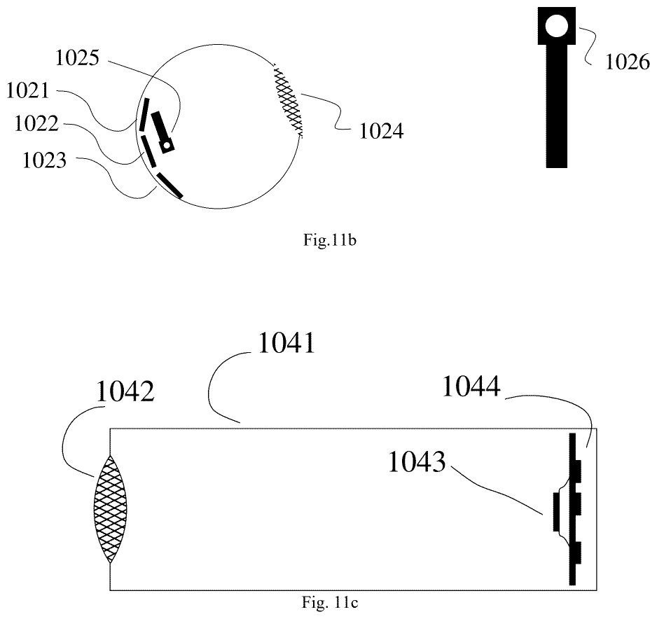

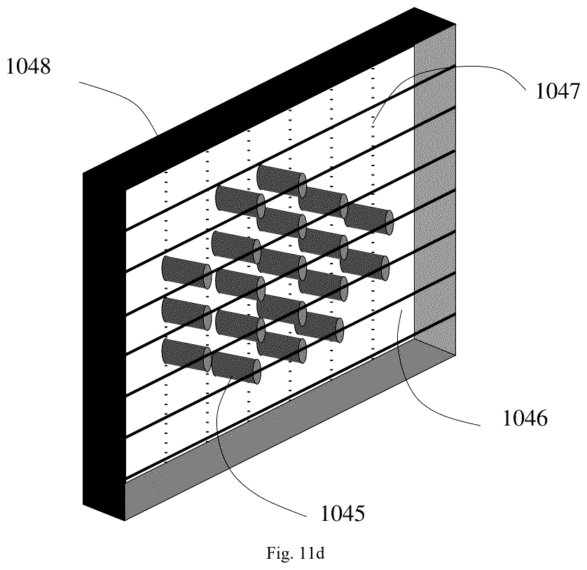

A further way to distinguish the light retroreflected from different retroreflectors would be to use retroreflection which is efficient for certain wavelengths only, e.g. in the case described above for the n=2 sphere by using different retroreflective materials that have each have a different dispersion so that retroreflection would be observable only for certain light wavelengths. Another way to introduce a wavelength dependency would be to place interference filters 1001, 1002 in front of the retroreflector or in front of a part of the entrance window into a retroreflector 1003 as shown in FIG. 10.

Depending on the wavelength, light is then either passed through the filter 1004 and subsequently retro-reflected, or it is reflected 1005 at the filter into a direction far away from the source of the incident light. In either case, there is very little absorption, thus minimizing heat load on the filter-retroreflector assembly.

This might e.g. help to more clearly distinguish retroreflected light from background light, for example when determining the footprint of heliostat mirrors using reference retroreflectors outside the central hot zone.

Typically, however, any glass used for the retroreflectors or a housing therof might be uncoated, e.g., uncoated quartz glass, or might only be coated to block thermal radiation in the far IR range.

The photosensors will typically have optics to image the reference region and/or the entire sunlight collecting area and/or parts thereof. If the photosensors are placed on a heliostat mirror—as is preferred—and is oriented such that it receives light from in a direction perpendicular to the heliostat mirror surface, it will not “look” into the direction from which the retroreflection is received if the sun is incident on the heliostat mirror with a non-perpendicular angle. There are several ways to receive retroreflected light at the photosensors nonetheless. The first is to provide the photosensor with a wide angle-entrance optic so that light is received from any angle or at least any relevant angle without additional measures. To this end, a wide angle lens such as a fish eye lens can be placed in front the photosensor or no lens could be provided at all as long as the photosensor is sufficiently sensitive for light incident under an oblique angle.

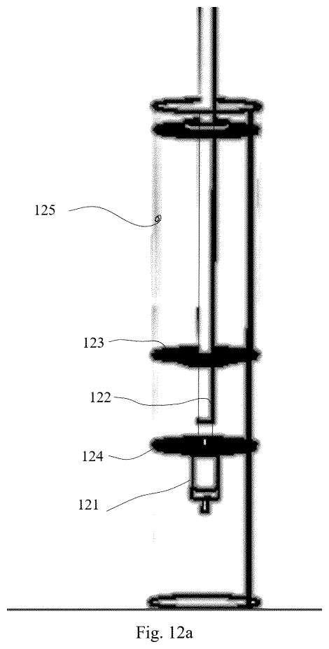

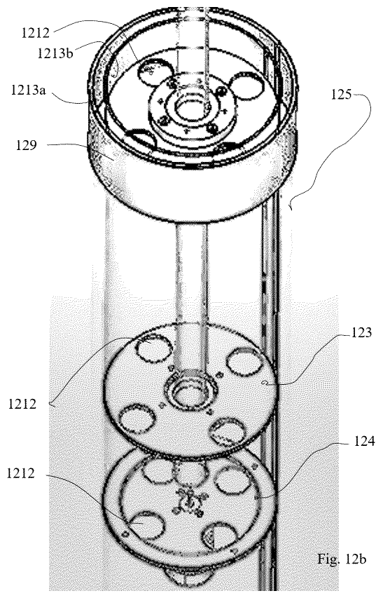

Another possibility is to readjust the orientation of the direction the photosensor is looking to in a manner dependent on the orientation of the mirror relative to the sun. This allows for a narrower angle of view and thus better background suppression, albeit typically, the retroreflection should be bright enough to be detectable even against a brightly illuminated collector. More precisely, the re-orientation of the photosensor would then have to be such that the photosensor is compensating for the changing orientation of the heliostat platform. Such counter-movement would need to be accurate within the angle subtended by the collector as seen from a heliostat, i.e., several milli-radians if a very narrow field of view is provided by a photosensor entrance optics, but the precision can be significantly relaxed if the field of view of the photosensor is made somewhat wider, even when not providing for a wide-angle view. Thus, typically, the accuracy need not be as high as that of the actuators moving the photosensor assembly, as the signal from the retroreflectors, particularly in view of the signal modulation, will stand out clearly enough to discriminate against stray light from the collector or a much darker (but still bright) background sky, even when cloudless. Furthermore, the motion will be rather slow, of the order of radians per day. Therefore, a possible low-cost approach is to use piezo motors similar to those in autofocusing camera lenses, but with much lower performance requirements. A corresponding design example is shown in FIG. 11a where a spherical body 1101 (photo) containing a lens 1102 opposite from a photodiode 1103 and other electronics sits like an eyeball inside a socket 1104, imaging 1105 the tower 1106 with sunlight collector onto the photodiode. It is driven in two-dimensional angular motion by the aforementioned piezo motor 1107, such as a stick-slip device, ultrasonic motor, or a piezo-walker. These devices are usually designed for one-dimensional motion, but can, in principle, also be made for two dimensions. For example, in the case of a stick-slip motor, the piezo is shaped like a rod with one tip touching the sphere. This rod is made to bend by application of electric fields between typically three or four partially-cylindrical electrodes on its outside. This allows to bend it fast in one way, causing it to slip above the surface of the sphere; when allowing it to bend back more slowly, it will drag the sphere along by friction. This stick-slip action can be supported by electric-field-driven longitudinal contraction/expansion. The entire assembly may be enclosed in a bubble-like transparent enclosure to keep dust from jamming the mechanism. The photosensor assembly can be implemented without a large wiring effort: the signal-processing electronics and the piezo actuators only need minimal power, which can be supplied by a small photovoltaic module or even the sensor photodiode itself. This power would also suffice for operating a short-range, low-data-rate wireless equipment. Accordingly, signals could be transmitted to the light signal evaluation stage in a wireless manner.

A mechanically simpler possibility to take into account the movement of the mirror and the resulting misalignment of a photosensor arrangement for retroreflection light detection is explained with respect to FIG. 11b.

According to FIG. 11b, another way of selective reception of the light from the retroreflectors is to use a photodiode array, here represented by photodiodes 1021, 1022, and 1023, but typically made up of many more photodiodes, that is fixed relative to its heliostat frame In front of the photodiode array, a lens 1024 is placed such that an image 1025 of the solar light collecting area 1026, is projected onto one or a few of the diodes, here photodiode 1022 of the photodiode array. Realigning the mirror to account for the movement of the sun across the sky or the necessity to direct radiation onto a different part of collector hot zone will cause the image projected onto the photodiode array to move across the photodiode array. Accordingly, by selecting different photodiodes in the array, the movement can be accounted for without using any moving parts, even though the angular range from which the arrangement shown in FIG. 11b is somewhat limited due to the typical aberrations of cheap imaging lenses.

In yet another way of selective reception, the photosensors each comprise an optical tube 1041 with a lens 1042 on one end and a photodiode 1043 on the other end, preferably directly connected to associated electronics 1044, cmp. FIG. 11c and FIG. 11d. As shown in FIG. 11d, a plurality of such photosensors, such as the one referenced as 1045 in FIG. 11c, are each attached by one end to wires 1046 running in one direction, and by their respective other ends to wires 1047 running in another direction, typically perpendicular to that of the wires 1046. These sets of wires 1046 and 1047 are strung on a frame 1048 which contains actuators to collectively pull along wire sets 1046 and 1047, thus inducing a collective tip-tilt motion on all photosensor tubes 1045 attached by their ends to the wires. A frame 1048 is then mounted to each heliostat, the angular motion of which is compensated by the tip-tilt motion of the photosensors, so that they maintain alignment towards the sunlight collector. Note that this alignment does not need to be very precise because the sunlight collector and the retroreflected light from its vicinity are, by far, the brightest objects in the field of view of the photosensors. It is therefore possible, without losing significantly in terms of signal-to-background ratio, to use a wide-angle optical system that images the sunlight receiver and a large solid angle around it onto the photodiode in the photosensor.

It should be emphasized that both the sun and retroreflected light can be simultaneously observed using a digital image sensor and a wide angle lens in front thereof. If the digital image sensor can be read out sufficiently fast, it is possible to even determine the modulation of the retroreflected light received on specific pixels or pixel areas of the digital image sensor.

It has been emphasized above that placing the retroreflectors in the path of concentrated sunlight right in front of the collector and hence right in front of the sunlight collecting area creates a number of technological challenges due to the extreme high intensity of sunlight that might be encountered; concentrated sunlight intensities of e.g. 1 MW/m2 are easily observed in front of the sunlight collecting area and in addition to the sunlight reflected onto the front side by the heliostats, strong thermal radiation will occur from the heat collector. Therefore, the retroreflector arrangement must be able to withstand these extreme conditions. In particular, any absorption of thermal or visible radiation by material used will lead to very significant and often very rapid heating thereof.

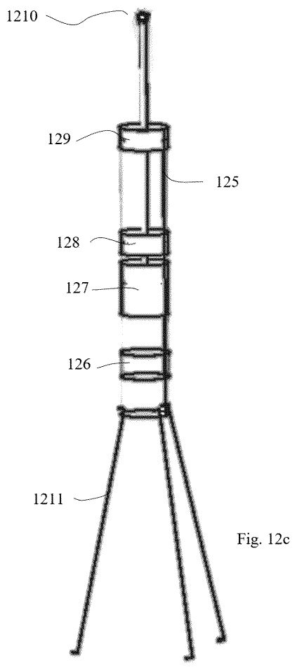

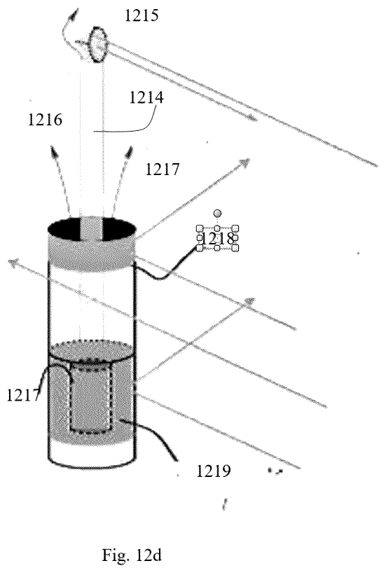

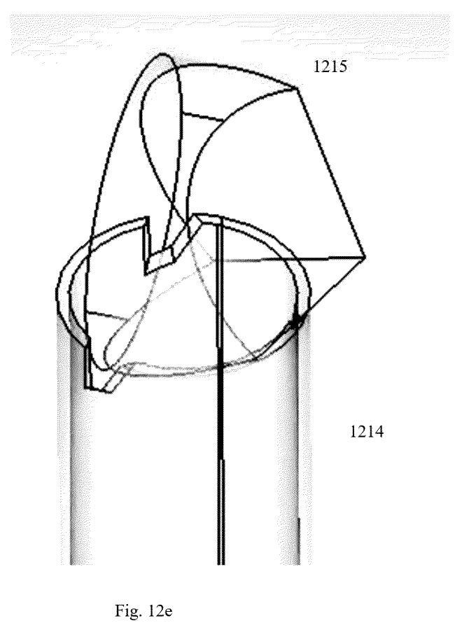

Now, as suggested above, a preferred way to modulate the retroreflection is to rotate a retroreflector such as a corner-cube retroreflector cubeor an n=2-sphere with patterns on its surface to obtain the modulation. In order to achieve this rotation despite the adverse conditions encountered close to the sunlight collecting area, several possibilities will be disclosed hereinafter with respect to FIG. 12.

According to FIG. 12a, the rotation of the retroreflector can be effected by an electrical motor 121. To this end, an electrical motor driving a spindle 122 which in turn carries the retroreflector (not shown in FIG. 12a, see 1210 in FIG. 12d) is provided along with bearings 123, 124 holding the spindle in a desired, here upright orientation.

To avoid absorption of at least the high intensity visible radiation by the housing itself, the housing is made of quartz glass tubes. Also, the housing can be placed on support struts 1211 also made of quartz glass (see FIG. 12c).

However, at least part of the electrical motor, the bearing and the spindle will be made of material that will absorb both visible and IR radiation. To prevent such radiation from reaching the components mentioned, where these components are placed inside a housing 125, sections (126-129 in FIG. 12 d) of mirror coating are provided around the non-transparent components (bearings 122, 123 and electrical motor 121) for reflecting a major part of both the IR and visible radiation.

However, a typical mirror coating made of silver or aluminum will still have an absorption of about 1-2% of the incident light. Given the extreme high irradiation intensities, a double-walled quartz glass tube is suggested with air flowing both through the inner tube and between the inner and the outer tube. As can be seen in FIG. 12b, the bearings 123,124,125 are provided with vent holes 1212 (with reference signs being shown only for some of the vent holes) have been allowing a continuous flow of air. Using a double-walled tubular arrangement as seen in FIG. 12b where a double wall 1213a and 1213b can be seen, allows to have the inner driving parts at a temperature significantly lower than the heat collector temperature, provided the air flow is adequate. In this respect, it should be understood that the amount of air needed for cooling is substantial and that accordingly, the dimensions of the tubular arrangement must be adequately sized. As an example, the air flow needed to keep the inner tube of a double-walled structure where the outer tube 1213a has exterior/interior diameters of 240/230 mm, and the inner tube 1213b has 206/200 mm diameters at about 100 °C in a 500 MW concentrated solar power facility with a 500 m2 collector can be calculated to be about 671/min for the annular outer structure and about 80 l/min for the inner structure.

Where such strong air flow is to be avoided, a more transparent structure can be provided as shown in FIG. 12b, where the drive unit is further away from the retroreflector so that it can in theory the drive mechanism could be placed outside the hot zone. When a quartz tube is used as a spindle, it can be formed to provide a seat for the retroreflector as shown in FIG. 12c, with the retroreflector being laser-welded or ultrasonic-welded to the spindle. Again, cooling by cold air of this arrangement is possible, although the thermal load and hence the air flow needed is significantly lower. It is possible to place either arrangement on quartz struts 1211 or quarts holders as shown in FIG. 12c for the embodiment of FIG. 12a.

Another possibility leading to a reduced heating of the arrangement is shown with respect to FIG. 12d and FIG. 12e. In FIG. 12d, the spindle is replaced by a quartz glass tube 1214 so that the absorption is significantly lower than for a metal spindle. On top of the quartz glass tube 1214, the retroreflector 1215 is placed, cmp. FIG. 12e. The retroreflector need not necessarily be placed inside a vented quartz glass housing, but could be cooled by a stream of air 1216 used for cooling the motor and (non-quartz glass) bearings (not shown) and coming out of the housing below the retroreflector. Again, reflecting areas 1218,1291 might be provided around the housing to reduce the absorption by non-transparent components such as the motor and bearing.

A further possibility which, although not shown in the drawings, has some advantages over the previous two embodiments, is to use a retroreflector arrangement where those parts that are placed in front of the sunlight collecting area are made entirely or at least almost entirely from quartz glass. To this end, the retroreflector is placed on an air bearing and driven by the air streaming through said bearing and/or quartz glass made fans. In this manner, all relevant parts for the driving mechanism that need to be subjected to the high radiation intensities can be made of low absorbing material.

From the above, the skilled person will understand that the technical disclosure given above allows for substantive improvements of the operation and construction of concentrated solar power facilities, retroreflector arrangements, communication between heliostats and a control center and so forth. In particular, it is possible to adjust mirrors using local feedback control. Furthermore, it is possible to adjust mirrors rapidly and frequently. It is possible to adjust mirrors more precisely, allowing to achieve higher temperatures and/or efficiencies. It is possible to determine the radiant footprint. It is possible to determine the radiant footprint in a manner not requiring additional hardware. It is possible to determine the radiant footprint without interrupting operation of the facility. It is possible to determine the radiant footprint while the mirror still is reflecting sunlight into the sunlight collecting area. It is possible to take into account nonperfect radiant footprints and to alleviate the effects of nonperfect radiant footprints. The disclosure given above allows to obtain such advantages alone, that is without simultaneously obtaining other advantages or in combination with other advantages.

1. A concentrated solar power facility comprising:
a sun light collector having a sun light collecting area;
a plurality of heliostat mirror arrangements for reflecting sun light onto the sun light collector;
a plurality of light modulating retroreflectors for reflecting modulated light from the sun light collector back to the heliostat mirrors;
a plurality of light sensors arranged to receive light reflected back to the heliostat mirrors and to output a light detection signal in response to the reception of modulated light reflected back to the mirrors;
a light signal evaluation stage for demodulating the light detection signal and for generating a heliostat mirror adjustment signal light signal;
wherein
at least a part of the retroreflectors
is arranged
adjacent to and in front of
or within the sun light collecting area
and in the optical path of light concentrated from a plurality of mirrors directed towards the sun light collecting area,
is made from a material having low absorption for visible sunlight,
is preferably at least temporarily shielded from and/or preferably cooled against thermal radiation from the sun light collecting area
and is modulating light with marginal or no absorption.

2-19. (canceled)

20. The concentrated solar power facility according to claim 1, wherein the alignment of heliostat mirrors is controlled using a control loop generating control signals in response to modulated light retroreflected from the sun light collecting area, preferably retroreflected by a plurality of retroreflectors in a manner also allowing determination of radiant footprints.

21. The concentrated solar power facility according to claim 20,
wherein the light modulating retroreflectors are based on total internal reflection
and wherein they are
adapted to have their reflectivity modulated by altering the efficiency of total internal reflection,
in particular
by altering at least one of altering the width of a gap between a total internal reflection-active surface and a matching surface of a piece of a material with a refractive index greater than unity
or
by altering the refractive index within a gap between a total-internal reflection active surface and a matching surface of a piece of a material with a refractive index greater than unity
and/or wherein they comprise
an arrangement to rotate the retroreflectors in a manner such that retroreflected light is modulated, in particular by rotation of at least the part of the retroreflectors that is arranged adjacent to and in front of or within the sun light collecting area and in the optical path of light concentrated from a plurality of mirrors directed towards the sun light collecting area,
and wherein preferably
the modulation frequency is at least 0,1 Hz, preferably at least 1 Hz, preferably in particular at least 10 Hz, further preferably in particular at least 100 Hz and in particular at least 1 kHz.

22. The concentrated solar power facility according to claim 21 comprising a photodiode or a Position Sensing Photodiode (PSD) and circuitry adapted to detect a modulation in the range of up to at least 0.1 Hz, preferably up to at least 1 Hz, preferably in particular at least 10 Hz, further preferably in particular at least 100 Hz and in particular at least 1 kHz, for use in radiant footprint determination.

23. A concentrated solar power facility according to claim 22, wherein the light sensors are positioned close to or within the reflecting area of the respective heliostat mirrors.

24. The concentrated solar power facility according to claim 23, wherein the light signal evaluation stage is adapted to evaluate the retroreflected light in a manner such that a radiant footprint of a mirror or the radiant footprint of a group of mirrors is determined.

25. The concentrated solar power facility according to claim 24 comprising a control adapted to align or adjust one or more mirrors in response to radiant footprints determined, preferably in a response to commands issued from a central control.

26. The concentrated solar power facility according to claim 24, wherein a plurality of the retroreflectors is placed in one or more reference regions close to or in front of the collector, and wherein at least some of those retroreflectors are contained in one or more cooled housings having highly light-reflective walls between the reflector and the collector to protect the retroreflector from radiant heat due to concentrated sunlight directed towards the collector and/or the due to the (infrared) heat radiation from the collector.

27. The concentrated solar power facility according to claim 24, wherein the light sensors comprise both a digital image sensor (DIS) as well as a lens for simultaneously observing the sun and the retroreflectors and wherein the light signal evaluation stage is adapted to determine an overall orientation of the heliostat mirror relative to the sun.

28. The concentrated solar power facility according to claim 26, wherein the mirrors focus light onto the light collecting area in an adjustable manner and the light signal evaluation stage is adapted to determine a quality of focusing of light onto the light collecting area, in particular in view of the signals from a plurality of retroreflectors.

29. The concentrated solar power facility according to claim 1, wherein the collector surface is provided with a coating
highly absorptive at visible and near-infrared wave lengths
and highly reflective at the far-infrared wavelengths.

30. The concentrated solar power facility according to claim 1, wherein at least some of the retroreflectors are placed in one or more reference regions close to or in front of the collector.

31. The concentrated solar power facility according to claim 30, wherein the retroreflectors are contained in one or more cooled housings having highly light-reflective walls between the reflector and the collector to protect the retroreflector from radiant heat due to concentrated sunlight directed towards the collector and/or the due to the (infrared) heat radiation from the collector.

32. The concentrated solar power facility according to claim 31, wherein the retroreflectors are provided with a defocusing lens arrangement on the entrance/exit window of each retro-reflector.

33. The concentrated solar power facility according to claim 32, wherein retroreflectors based on total internal reflection are used and the total internal reflection is frustrated for some entrance angles so as to provide for a modulation of the retroreflected beam.

34. The concentrated solar power facility according to claim 33, wherein alignment of heliostat mirrors is controlled using a control loop generating control signals in response to modulated light retroreflected from the sun light collecting area and/or retroreflected by a plurality of retroreflectors in a manner allowing determination of radiant footprints.

35. A retroreflector arrangement adapted for use in the concentrated solar power facility according to claim 1.
